(19) United States
(12) Patent Application Publication
(10) Pub. No.: US 2024/0278487 A1
(43) Pub. Date: Aug. 22, 2024

(54) THREE-DIMENSIONAL PRINTING

(71) Applicants: HEWLETT-PACKARD DEVELOPMENT COMPANY , L.P., Spring, TX (US); NANYANG TECHNOLOGICAL UNIVERSITY, Singapore (SG)

(72) Inventors: Jiayao CHEN, Singapore (SG); Kun ZHOU, Singapore (SG); Lihua ZHAO, Palo Alto, CA (US)

(73) Assignees: HEWLETT-PACKARD DEVELOPMENT COMPANY , L.P., Spring, TX (US); NANYANG TECHNOLOGICAL UNIVERSITY, Singapore (SG)

(21) Appl. No.: 18/565,648

(22) PCT Filed: Jun. 3, 2021
(86) PCT No.: PCT/US2021/035669

§ 371 Date: Nov. 30, 2023

(51) Int. Cl. B29C 64/165; B29C 64/188; B29K 77/00; B29K 105/00; B29K 105/12; B29K 477/00; B33Y 10/00; B33Y 40/20; B33Y 70/00

(52) U.S. Cl. CPC B29C 64/165; B29C 64/188; B33Y 10/00; B33Y 40/20; B33Y 70/00; B29K 2077/00; B29K 2105/0005; B29K 2105/12; B29K 2105/251; B29K 2477/10

(57) ABSTRACT

A three-dimensional (3D) printing build material composition includes polyamide particles and a filler material consisting of aramid fibers having an aspect ratio ranging from about 0.1 mm/20 μm to about 1.2 mm/16 μm. The polyamide particles are present in an amount of at least 82 wt % based on a total weight of the build material composition, and the aramid fibers are present in an amount ranging from about 2 wt % to about 18 wt % based on the total weight of the build material composition.

### BACKGROUND

Three-dimensional (3D) printing is an additive manufacturing process used to make three-dimensional solid parts from a digital model. 3D printing techniques are considered additive manufacturing processes because they involve the application of successive layers of material (which, in some examples, may include build material, binder and/or other printing liquid(s), or combinations thereof). This is unlike traditional machining processes, which often rely upon the removal of material to create the final part. 3D printing is often used in rapid product prototyping, mold generation, mold master generation, and short run manufacturing for mass personalization and customization of goods.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram illustrating an example 3D printing technique;

FIG. 2 is a schematic diagram illustrating another example 3D printing technique;

FIG. 3 is a schematic, cross-sectional view, taken in the Y-Z plane, of an example of a 3D printed object printed from the bottom to the top on a build area platform having an X-Y plane;

FIG. 4 is a schematic, cross-sectional view, taken in the Y-Z plane, of another example of a 3D printed object printed from the bottom to the top on a build area platform having an X-Y plane;

FIGS. 5A through 5D are scanning electron micrograph (SEM) images of example aramid fibers of different lengths (FIG. 5A through FIG. 5C) and of comparative aramid fibers of random form (FIG. 5D);

FIG. 6 is a schematic, perspective view of a build area platform and three dog bone shaped 3D objects printed in the X-direction (object X), the Y-direction (object Y), and the Z-direction (Z);

FIG. 7 is a graph depicting the average ultimate tensile strength (UTS, in MPa) of different dog bone shaped 3D objects versus the weight fraction (wt %) of the example aramid fibers in the dog bone shaped 3D objects;

FIG. 8A is a graph depicting the average ultimate tensile strength (UTS, in MPa) of different dog bone shaped 3D objects printed in the X-direction, the Y-direction, and the Z-direction versus the weight fraction (wt %) of the example aramid fibers in the dog bone shaped 3D objects;

FIG. 8B is a graph depicting the average Young's Modulus (GPa) of different dog bone shaped 3D objects printed in the X-direction, the Y-direction, and the Z-direction versus the weight fraction (wt %) of the example aramid fibers in the dog bone shaped 3D objects;

FIG. 8C is a stress (MPa) versus strain (%) graph of different dog bone shaped 3D objects printed in the X-direction and the Y-direction; and

FIG. 9A through FIG. 9C are SEM images illustrating the fracture morphologies of a dog bone shaped 3D object printed in the X-direction (FIG. 9A), a dog bone shaped 3D object printed in the Y-direction (FIG. 9B), and a dog bone shaped 3D object printed in the Z-direction (FIG. 9C), where each inset schematically illustrates the alignment of the aramid fibers within the corresponding printed object.

### DETAILED DESCRIPTION

The three-dimensional (3D) printing techniques disclosed herein utilize a build material composition that includes polyamide particles and aramid fibers having an average aspect ratio ranging from about 0.5 mm/20 μm to about 1.2 mm/16 μm. 3D printed objects formed with the build material compositions including the aramid fibers disclosed herein unexpectedly exhibit mechanical and flexural anisotropy along the spreading direction of the build material composition, with significantly improved tensile performance and flexural properties compared to 3D printed objects formed with neat polyamide particles and/or comparative compositions that include polyamide particles and random form aramid fibers. These 3D printed objects are believed to be comparable, in terms of flexural properties, to many other fiber-reinforced composites. Additionally, the effect that the aramid fibers have on the density of the 3D printed object is minimal, and in some instances, the density may be reduced when compared to a similar 3D object generated with neat polyamide particles. As such, the aramid fibers set forth herein may be particularly desirable for lightweight manufacturing.

Throughout this disclosure, a weight percentage that is referred to as “wt % active” refers to the loading of an active component of stock formulation that is present, e.g., in a fusing agent, detailing agent, etc. For example, an energy absorber, such as carbon black, may be present in a water-based formulation (e.g., a stock solution or dispersion) before being incorporated into the fusing agent vehicle. In this example, the wt % actives of the carbon black accounts for the loading (as a weight percent) of the carbon black solids that are present in the fusing agent, and does not account for the weight of the other components (e.g., water, etc.) that are present in the stock solution or dispersion with the carbon black. The term “wt %,” without the term actives, refers to the loading of a 100% active component that does not include other non-active components therein.

### Build Material Composition

The three-dimensional (3D) printing build material composition includes polyamide particles present in an amount of at least 82 wt % based on a total weight of the build material composition and a filler material consisting of aramid fibers having an average aspect ratio ranging from about 0.1 mm/20 μm to about 1.2 mm/16 μm, the aramid fibers present in an amount ranging from about 2 wt % to about 18 wt % based on the total weight of the build material composition.

Examples of suitable polyamides include polyamide-11 (PA 11/nylon 11), polyamide-12 (PA 12/nylon 12), polyamide-6 (PA 6/nylon 6), polyamide-8 (PA 8/nylon 8), polyamide-9 (PA 9/nylon 9), polyamide-66 (PA 66/nylon 66), polyamide-612 (PA 612/nylon 612), polyamide-812 (PA 812/nylon 812), polyamide-912 (PA 912/nylon 912), etc.), and combinations thereof.

The polyamide particles in the build material composition may be in the form of a powder.

The polyamide particles may be made up of similarly sized particles and/or differently sized particles. In an example, the average particle size of the polyamide particles ranges from about 20 μm to about 220 μm. As used herein, the term “average particle size” refers to the average diameter of the particles. In an example, the particle distribution (D10 to D90) ranges from about 30 μm to about 125 μm with a median diameter of about 60 μm (D50).

The polyamide particles are present in the build material composition in an amount of at least 82 wt % based on the total weight of the build material composition. In some instances, the build material composition consists of the polyamide particles and the aramid fibers, and thus the amount of the polyamide particles depends upon the amount of the aramid fibers. In other instances, the build material composition consists of the polyamide particles, the aramid fibers, and one or more of the additives set forth herein, and thus the amount of the polyamide particles depends upon the amount of the aramid fibers and the additive(s). In one example, the polyamide particles are present in an amount up to about 98 wt % based on the total weight of the build material composition. In other words, the polyamide particles make up from about 82 wt % to about 98 wt % of the build material composition. In other examples, the polyamide particles make up from about 85 wt % to about 95 wt % or from about 90 wt % to about 97 wt % of the build material composition.

The build material composition includes one type of filler material, namely aramid fibers having an average aspect ratio (length/diameter) ranging from about 0.1 mm/20 μm to about 1.2 mm/16 μm. As such, the build material composition is free of other filler materials, such as glass beads, glass fibers, carbon fibers, carbon nanotubes, aluminum fibers, graphene nanoplatelets, etc. It has been discovered that the aramid fibers disclosed herein, with the average aspect ratio within the provided range, become oriented along the spreading direction, which results in directionally reinforced three-dimensional objects. Similar reinforcement is not achieved with neat polyamide particles or with composites that include random form aramid fibers.

An aramid is a polyamide where at least 85% of the amide binds are attached to aromatic rings. In some instances, the aramid fibers may be surface treated (e.g., with plasma) to render them more hydrophilic.

The aramid fibers are present in the build material composition in an amount ranging from about 2 wt % to about 18 wt % based on the total weight of the build material composition. The amount included depends, in part, upon the average aspect ratio of the fibers used. The aramid fibers with a shorter length (and thus a lower average aspect ratio) may be included in higher amounts without deleteriously affecting the ultimate tensile strength of the 3D printed object. In an example, the average aspect ratio of the aramid fibers ranges from about 0.1 mm/20 μm to about 0.35 mm/16 μm, and the aramid fibers are present in an amount ranging from about 2 wt % to about 18 wt % based on the total weight of the build material composition. In another example, the average aspect ratio of the aramid fibers ranges from about 0.5 mm/20 μm to about 0.55 mm/16 μm, and the aramid fibers are present in an amount ranging from about 2 wt % to about 14 wt % based on the total weight of the build material composition. In still another example, the average aspect ratio of the aramid fibers ranges from about 0.7 mm/20 μm to about 0.85 mm/16 μm, and the aramid fibers are present in an amount ranging from about 2 wt % to about 10 wt % based on the total weight of the build material composition. In yet another example, the average aspect ratio of the aramid fibers ranges from about 1.1 mm/20 μm to about 1.2 mm/16 μm, and the aramid fibers are present in an amount ranging from about 2 wt % to about 4 wt % based on the total weight of the build material composition.

In some examples, in addition to the polyamide particles and the aramid fibers, the build material composition may include a flow aid, an antioxidant, an antistatic agent, or a combination thereof. While several examples of these additives are provided, it is to be understood that these additives are selected to be thermally stable (i.e., will not decompose) at the 3D printing temperatures.

Flow aid(s) may be added to improve the coating flowability of the build material composition. Flow aids may be particularly beneficial when the polyamide particles in the build material composition have an average particle size less than 25 μm. The flow aid improves the flowability of the build material composition by reducing the friction, the lateral drag, and the tribocharge buildup (by increasing the particle conductivity). In one example, the flow aid is silica (SiO₂), e.g., hydrophobic fumed silica nanoparticles. Other examples of suitable flow aids include tricalcium phosphate (E341), powdered cellulose (E460(ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and polydimethylsiloxane (E900). In an example, the flow aid is present in an amount up to 0.2 wt % based on the total weight of the build material composition. As such, when included, the flow aid may range from greater than 0 wt % to 0.2 wt %, based upon the total weight of the build material composition. The flow aid may be in the form of fine particles (e.g., having a specific surface area ranging from about 100 m²/g to about 300 m²/g) that are dry blended with the polyamide particles and the aramid fibers.

Antioxidant(s) may be added to the build material composition to prevent thermal degradation of the polyamide particles and/or to further prevent or slow discoloration (e.g., yellowing) of the composition by preventing or slowing oxidation of the polyamide particles and the aramid fibers. In some examples, the antioxidant may be a radical scavenger. In these examples, the antioxidant may include IRGANOX® 1098 (benzenepropanamide, N,N′-1,6-hexanediylbis(3,5-bis(1,1-dimethylethyl)-4-hydroxy)), IRGANOX® 254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). In an example, the antioxidant may be included in the build material composition in an amount ranging from about 0.01 wt % to about 5 wt %, based on the total weight of the build material composition. In other examples, the antioxidant may be included in the build material composition in an amount ranging from about 0.01 wt % to about 2 wt % or from about 0.2 wt % to about 1 wt % or from about 0.1 wt % to about 0.3 wt %, based on the total weight of the build material composition. The antioxidant may be in the form of fine particles (e.g., having an average particle size of 5 μm or less, e.g., 3 μm, 1.5 μm, etc.) that are dry blended with the polyamide particles and the aramid fibers. Some antioxidants may be ground to reduce the particle size before being blended with the polyamide particles and the aramid fibers.

Antistatic agent(s) may be added to the build material composition to suppress tribo-charging. Examples of suitable antistatic agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available antistatic agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.). In an example, the antistatic agent is added in an amount ranging from greater than 0 wt % to less than 1 wt %, based upon the total weight of the build material composition. The antistatic agent may be introduced during manufacturing or compounded into the polyamide particles during processing.

The build material composition disclosed herein may be prepared by physical powder mixing the polyamide particles with the aramid fibers (alone or in combination with one or more of the other additives disclosed herein), and sieving the mixture. The mixing process may be a dry or wet mixing process. It is to be understood that the aramid fibers (before being mixed with the polyamide particles) or the mixture of the polyamide particles and the aramid fibers are not exposed to a grinding process that could alter the average aspect ratio of the aramid fibers.

### Fusing Agents

The build material composition disclosed herein may be used in a variety of additive manufacturing methods. One suitable additive manufacturing method involves the selective application of a fusing agent to pattern a layer of the build material composition, and exposure of the entire patterned layer to electromagnetic radiation. In this method, the patterned region (which, in some instances, is less than the entire layer) of the build material composition coalesces and solidifies to become a layer of a 3D object. A variety of fusing agents may be used in this technique, each of which includes an energy absorber. In some examples, the energy absorber exhibits absorption at least at some wavelengths within a range of from 100 nm to 4000 nm. Unless stated other, the term “absorption” means that 80% or more of the applied radiation having wavelengths within the specified range is absorbed by the energy absorber. Also unless stated otherwise, the term “transparency” means that 25% or less of the applied radiation having wavelengths within the specified range is absorbed by the energy absorber.

Several example fusing agents will now be described.

### Fusing Agent #1

One example of the fusing agent (fusing agent #1) is referred to herein as a core fusing agent, and the energy absorber in the core fusing agent has absorption at least at wavelengths ranging from 400 nm to 780 nm (e.g., in the visible region). The energy absorber in the core fusing agent may also absorb energy in the infrared region (e.g., 800 nm to 4000 nm). During 3D printing, the absorption of the energy absorber generates heat suitable for coalescing/fusing the build material composition in contact therewith, which leads to 3D printed polyamide objects having mechanical integrity and relatively uniform mechanical properties (e.g., strength, elongation at break, etc.). This absorption, however, also results in strongly colored, e.g., dark grey or black, 3D printed objects (or 3D printed object regions).

Examples of the energy absorber in the core fusing agent may be an infrared light absorbing colorant. In an example, the energy absorber is a near-infrared light absorbing colorant. Any near-infrared colorants, e.g., those produced by Fabricolor, Eastman Kodak, or BASF, Yamamoto, may be used in the core fusing agent. As one example, the core fusing agent may be a printing liquid formulation including carbon black as the energy absorber. Examples of this printing liquid formulation are commercially known as CM997A, 516458, C18928, C93848, C93808, or the like, all of which are available from HP Inc.

As another example, the core fusing agent may be a printing liquid formulation including near-infrared absorbing dyes as the active material. Examples of this printing liquid formulation are described in U.S. Pat. No. 9,133,344, incorporated herein by reference in its entirety. Some examples of the near-infrared absorbing dye are water-soluble near-infrared absorbing dyes selected from the group consisting of:

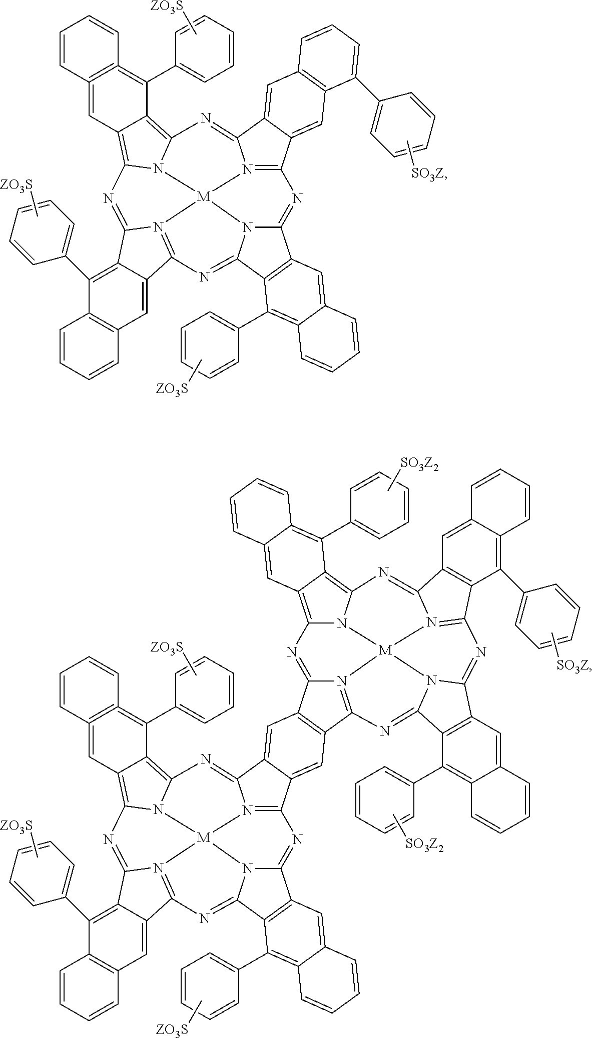

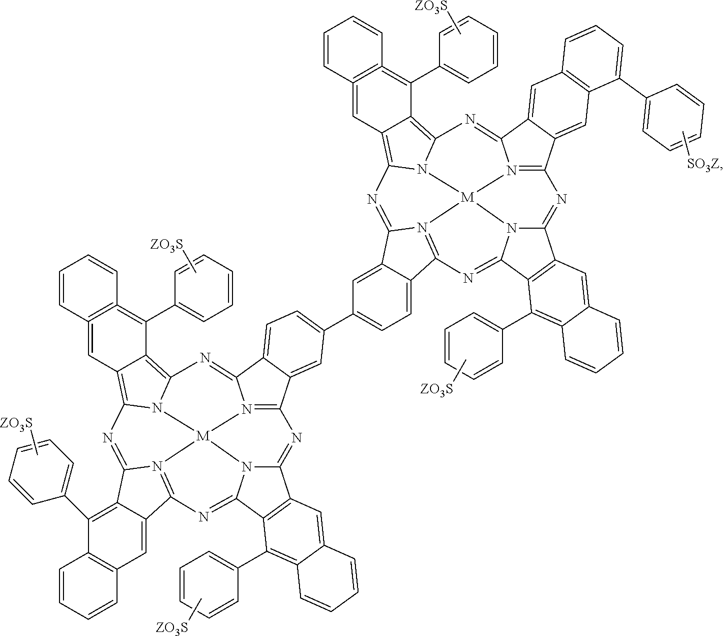

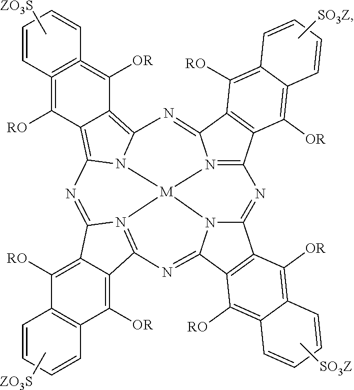

and mixtures thereof. In the above formulations, M can be a divalent metal atom (e.g., copper, etc.) or can have OSO₃Na axial groups filling any unfilled valencies if the metal is more than divalent (e.g., indium, etc.), R can be hydrogen or any C₁-C₈ alkyl group (including substituted alkyl and unsubstituted alkyl), and Z can be a counterion such that the overall charge of the near-infrared absorbing dye is neutral. For example, the counterion can be sodium, lithium, potassium, NH₄⁺, etc.

Some other examples of the near-infrared absorbing dye are hydrophobic near-infrared absorbing dyes selected from the group consisting of:

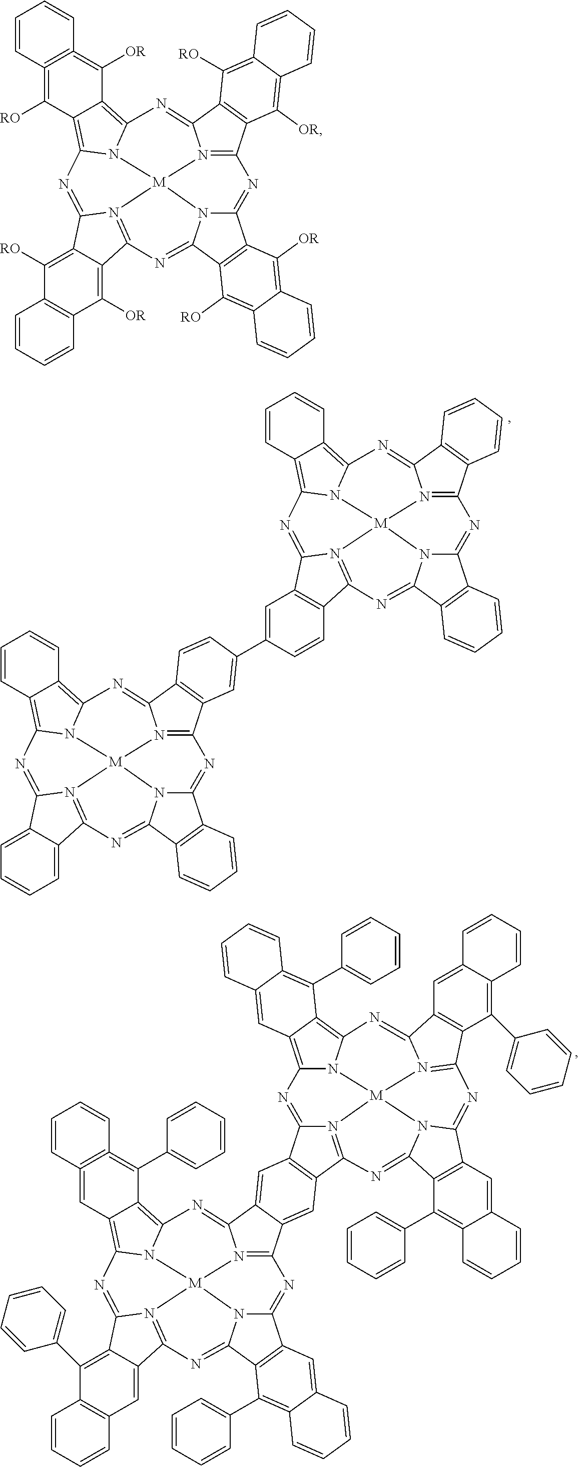

and mixtures thereof. For the hydrophobic near-infrared absorbing dyes, M can be a divalent metal atom (e.g., copper, etc.) or can include a metal that has Cl, Br, or OR′ (R′═H, CH₃, COCH₃, COCH₂COOCH₃, COCH₂COCH₃) axial groups filling any unfilled valencies if the metal is more than divalent, and R can be hydrogen or any C₁-C₈ alkyl group (including substituted alkyl and unsubstituted alkyl).

Other near-infrared absorbing dyes or pigments may be used in the core fusing agent. Some examples include anthraquinone dyes or pigments, metal dithiolene dyes or pigments, cyanine dyes or pigments, perylenediimide dyes or pigments, croconium dyes or pigments, pyrilium or thiopyrilium dyes or pigments, boron-dipyrromethene dyes or pigments, or aza-boron-dipyrromethene dyes or pigments.

Anthraquinone dyes or pigments and metal (e.g., nickel) dithiolene dyes or pigments may have the following structures, respectively:

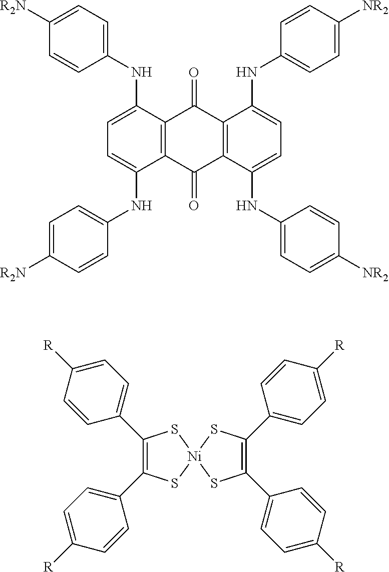

where R in the anthraquinone dyes or pigments may be hydrogen or any C₁-C₈ alkyl group (including substituted alkyl and unsubstituted alkyl), and R in the dithiolene may be hydrogen, COOH, SO₃, NH₂, any C₁-C₈ alkyl group (including substituted alkyl and unsubstituted alkyl), or the like.

Cyanine dyes or pigments and perylenediimide dyes or pigments may have the following structures, respectively:

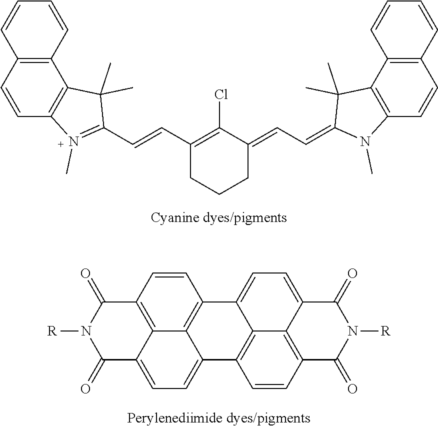

where R in the perylenediimide dyes or pigments may be hydrogen or any C₁-C₈ alkyl group (including substituted alkyl and unsubstituted alkyl).

Croconium dyes or pigments and pyrilium or thiopyrilium dyes or pigments may have the following structures, respectively:

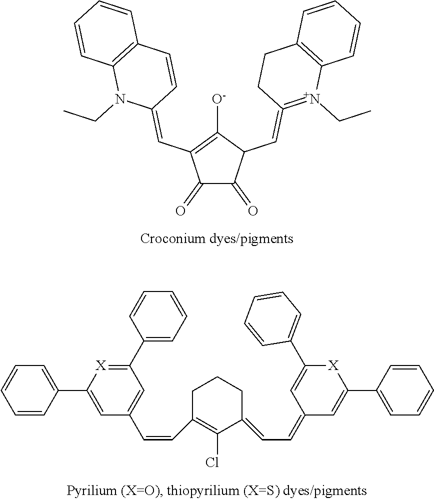

Boron-dipyrromethene dyes or pigments and aza-boron-dipyrromethene dyes or pigments may have the following structures, respectively:

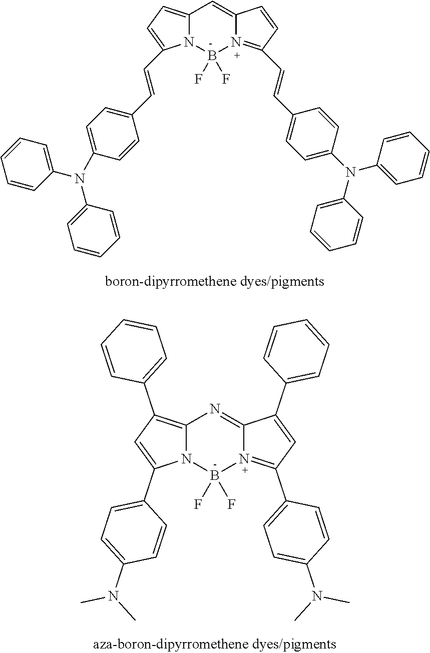

Other suitable near-infrared absorbing dyes may include aminium dyes, tetraaryldiamine dyes, phthalocyanine dyes, and others.

Other near infrared absorbing materials include conjugated polymers (i.e., a polymer that has a backbone with alternating double and single bonds), such as poly(3,4-ethylenedioxythiophene)-poly(styrenesulfonate) (PEDOT:PSS), a polythiophene, poly(p-phenylene sulfide), a polyaniline, a poly(pyrrole), a poly(acetylene), poly(p-phenylene vinylene), polyparaphenylene, or combinations thereof.

The amount of the energy absorber that is present in the core fusing agent ranges from greater than 0 wt % active to about 40 wt % active based on the total weight of the core fusing agent. In other examples, the amount of the active material in the core fusing agent ranges from about 0.3 wt % active to 30 wt % active, from about 1 wt % active to about 20 wt % active, from about 1.0 wt % active up to about 10.0 wt % active, or from greater than 4.0 wt % active up to about 15.0 wt % active. It is believed that these active material loadings provide a balance between the core fusing agent having jetting reliability and heat and/or radiation absorbance efficiency.

### Fusing Agent #2

Another example of the fusing agent (fusing agent #2) is referred to herein as a primer fusing agent or a low tint fusing agent, and the energy absorber in the primer fusing agent is a plasmonic resonance absorber having absorption at wavelengths ranging from 100 nm to 400 nm or 800 nm to 4000 nm and having transparency at wavelengths ranging from 400 nm to 780 nm. This absorption and transparency allow the primer fusing agent to absorb enough radiation to coalesce/fuse the build material composition in contact therewith, while enabling the 3D printed polyamide objects (or 3D printed regions) to be white or slightly colored.

Some examples of the primer fusing agent are dispersions including the energy absorber that has absorption at wavelengths ranging from 800 nm to 4000 nm and transparency at wavelengths ranging from 400 nm to 780 nm. The absorption of this energy absorber may be the result of plasmonic resonance effects. Electrons associated with the atoms of the energy absorber may be collectively excited by radiation, which results in collective oscillation of the electrons. The wavelengths that can excite and oscillate these electrons collectively are dependent on the number of electrons present in the energy absorber particles, which in turn is dependent on the size of the energy absorber particles. The amount of energy that can collectively oscillate the particle's electrons is low enough that very small particles (e.g., 1 nm to 100 nm) may absorb radiation with wavelengths several times (e.g., from 8 to 800 or more times) the size of the particles. The use of these particles allows the primer fusing agent to be inkjet jettable as well as electromagnetically selective (e.g., having absorption at wavelengths ranging from 800 nm to 4000 nm and transparency at wavelengths ranging from 400 nm to 780 nm).

In an example, the energy absorber of the primer fusing agent has an average particle size (e.g., volume-weighted mean diameter) ranging from greater than 0 nm to less than 220 nm. In another example, the energy absorber has an average particle size ranging from greater than 0 nm to 120 nm. In a still another example, the energy absorber has an average particle size ranging from about 10 nm to about 200 nm.

In an example, the energy absorber of the primer fusing agent is an inorganic pigment. Examples of suitable inorganic pigments include lanthanum hexaboride (LaB₆), tungsten bronzes (AₓWO₃), indium tin oxide (In₂O₃:SnO₂, ITO), antimony tin oxide (Sb₂O₃:SnO₂, ATO), titanium nitride (TiN), aluminum zinc oxide (AZO), ruthenium oxide (RuO₂), iron pyroxenes (AₓFe_{y}Si₂O₆ wherein A is Ca or Mg, x=1.5-1.9, and y=0.1-0.5), modified iron phosphates (AₓFe_{y}PO₄), modified copper phosphates (AₓCu_{y}PO_{z}), and modified copper pyrophosphates (AₓCu_{y}P₂O₇). Tungsten bronzes may be alkali doped tungsten oxides. Examples of suitable alkali dopants (i.e., A in AₓWO₃) may be cesium, sodium, potassium, or rubidium. In an example, the alkali doped tungsten oxide may be doped in an amount ranging from greater than 0 mol % to about 0.33 mol % based on the total mol % of the alkali doped tungsten oxide. Suitable modified iron phosphates (AₓFe_{y}PO) may include copper iron phosphate (A=Cu, x=0.1-0.5, and y=0.5-0.9), magnesium iron phosphate (A=Mg, x=0.1-0.5, and y=0.5-0.9), and zinc iron phosphate (A=Zn, x=0.1-0.5, and y=0.5-0.9). For the modified iron phosphates, it is to be understood that the number of phosphates may change based on the charge balance with the cations. Suitable modified copper pyrophosphates (AₓCu_{y}P₂O₇) include iron copper pyrophosphate (A═Fe, x=0-2, and y=0-2), magnesium copper pyrophosphate (A═Mg, x=0-2, and y=0-2), and zinc copper pyrophosphate (A═Zn, x=0-2, and y=0-2). Combinations of the inorganic pigments may also be used.

The amount of the energy absorber that is present in the primer fusing agent ranges from greater than 0 wt % active to about 40 wt % active based on the total weight of the primer fusing agent. In other examples, the amount of the energy absorber in the primer fusing agent ranges from about 0.3 wt % active to 30 wt % active, from about 1 wt % active to about 20 wt % active, from about 1.0 wt % active up to about 10.0 wt % active, or from greater than 4.0 wt % active up to about 15.0 wt % active. It is believed that these energy absorber loadings provide a balance between the primer fusing agent having jetting reliability and heat and/or radiation absorbance efficiency.

The energy absorber of the primer fusing agent may, in some instances, be dispersed with a dispersant. As such, the dispersant helps to uniformly distribute the energy absorber throughout the primer fusing agent. Examples of suitable dispersants include polymer or small molecule dispersants, charged groups attached to the energy absorber surface, or other suitable dispersants. Some specific examples of suitable dispersants include a water-soluble acrylic acid polymer (e.g., CARBOSPERSE® K7028 available from Lubrizol), water-soluble styrene-acrylic acid copolymers/resins (e.g., JONCRYL® 296, JONCRYL® 671, JONCRYL® 678, JONCRYL® 680, JONCRYL® 683, JONCRYL® 690, etc. available from BASF Corp.), a high molecular weight block copolymer with pigment affinic groups (e.g., DISPERBYK®-190 available BYK Additives and Instruments), or water-soluble styrene-maleic anhydride copolymers/resins.

Whether a single dispersant is used or a combination of dispersants is used, the total amount of dispersant(s) in the primer fusing agent may range from about 10 wt % to about 200 wt % based on the weight of the energy absorber in the primer fusing agent.

A silane coupling agent may also be added to the primer fusing agent to help bond the organic (e.g., dispersant) and inorganic (e.g., pigment) materials. Examples of suitable silane coupling agents include the SILQUEST® A series manufactured by Momentive.

Whether a single silane coupling agent is used or a combination of silane coupling agents is used, the total amount of silane coupling agent(s) in the primer fusing agent may range from about 0.1 wt % active to about 50 wt % active based on the weight of the energy absorber in the primer fusing agent. In an example, the total amount of silane coupling agent(s) in the primer fusing agent ranges from about 1 wt % active to about 30 wt % active based on the weight of the energy absorber. In another example, the total amount of silane coupling agent(s) in the primer fusing agent ranges from about 2.5 wt % active to about 25 wt % active based on the weight of the energy absorber.

One example of the primer fusing agent includes cesium tungsten oxide (CTO) nanoparticles as the energy absorber. The CTO nanoparticles have a formula of CsₓWO₃, where 0<x<1. The cesium tungsten oxide nanoparticles may give the primer fusing agent a light blue color. The strength of the color may depend, at least in part, on the amount of the CTO nanoparticles in the primer fusing agent. When it is desirable to form an outer white layer on the 3D printed polyamide object, less of the CTO nanoparticles may be used in the primer fusing agent in order to achieve the white color. In an example, the CTO nanoparticles may be present in the primer fusing agent in an amount ranging from about 1 wt % active to about 20 wt % active (based on the total weight of the primer fusing agent).

The average particle size of the CTO nanoparticles may range from about 1 nm to about 40 nm. In some examples, the average particle size of the CTO nanoparticles may range from about 1 nm to about 15 nm or from about 1 nm to about 10 nm. The upper end of the particle size range (e.g., from about 30 nm to about 40 nm) may be less desirable, as these particles may be more difficult to stabilize.

This example of the primer fusing agent may also include a zwitterionic stabilizer. The zwitterionic stabilizer may improve the stabilization of this example of the primer fusing agent. While the zwitterionic stabilizer has an overall neutral charge, at least one area of the molecule has a positive charge (e.g., amino groups) and at least one other area of the molecule has a negative charge. The CTO nanoparticles may have a slight negative charge. The zwitterionic stabilizer molecules may orient around the slightly negative CTO nanoparticles with the positive area of the zwitterionic stabilizer molecules closest to the CTO nanoparticles and the negative area of the zwitterionic stabilizer molecules furthest away from the CTO nanoparticles. Then, the negative charge of the negative area of the zwitterionic stabilizer molecules may repel CTO nanoparticles from each other. The zwitterionic stabilizer molecules may form a protective layer around the CTO nanoparticles, and prevent them from coming into direct contact with each other and/or increase the distance between the particle surfaces (e.g., by a distance ranging from about 1 nm to about 2 nm). Thus, the zwitterionic stabilizer may prevent the CTO nanoparticles from agglomerating and/or settling in the primer fusing agent.

Examples of suitable zwitterionic stabilizers include C₂ to C₈ betaines, C₂ to C₈ aminocarboxylic acids having a solubility of at least 10 g in 100 g of water, taurine, and combinations thereof. Examples of the C₂ to C₈ aminocarboxylic acids include beta-alanine, gamma-aminobutyric acid, glycine, and combinations thereof.

The zwitterionic stabilizer may be present in the primer fusing agent in an amount ranging from about 2 wt % active to about 35 wt % active (based on the total weight of the primer fusing agent). When the zwitterionic stabilizer is the C₂ to C₈ betaine, the C₂ to C₈ betaine may be present in an amount ranging from about 8 wt % to about 35 wt % active of the total weight of the primer fusing agent. When the zwitterionic stabilizer is the C₂ to C₈ aminocarboxylic acid, the C₂ to C₈ aminocarboxylic acid may be present in an amount ranging from about 2 wt % active to about 20 wt % active of the total weight of the primer fusing agent. When the zwitterionic stabilizer is taurine, taurine may be present in an amount ranging from about 2 wt % active to about 35 wt % active of the total weight of the primer fusing agent.

In this example, the weight ratio of the CTO nanoparticles to the zwitterionic stabilizer may range from 1:10 to 10:1; or the weight ratio of the CTO nanoparticles to the zwitterionic stabilizer may be 1:1.

### Fusing Agent #3

Still another example of the fusing agent (fusing agent #3) is referred to herein as an ultraviolet (UV) light fusing agent, and the energy absorber in the UV fusing agent is a molecule or compound having absorption at wavelengths ranging from 100 nm to 400 nm. These energy absorbers efficiently absorb the UV radiation, convert the absorbed UV radiation to thermal energy, and promote the transfer of the thermal heat to build material composition in order to coalesce the build material composition.

The UV fusing agent can be used with a narrow-band emission source, such as UV light emitting diodes (LEDs), which reduces the band of photon energies to which the non-patterned build material is exposed and thus potentially absorbs. This can lead to more accurate object shapes and reduced rough edges. Some UV energy absorbers are substantially colorless and thus can generate much lighter (e.g., white, off-white, or even translucent) 3D objects than infrared (IR) and/or visible radiation absorbers.

Some examples of UV energy absorbers suitable for the UV fusing agent include a B vitamin and/or a B vitamin derivative. Any B vitamins and/or B vitamin derivatives that are water soluble and that have absorption at wavelengths ranging from about 340 nm to about 415 nm may be used in the UV light fusing agent. As used herein, the phrase “that has absorption at wavelengths ranging from about 340 nm to about 415 nm” means that the B vitamin or B vitamin derivative exhibits maximum absorption at a wavelength within the given range and/or has an absorbance of about 0.1 (about 80% transmittance or less) at one or more wavelengths within the given range. Some of the B vitamins or B vitamin derivatives have lower absorbance. These B vitamins or B vitamin derivatives can still result in suitable coalescence and fusing when they are coupled with a higher intensity and/or a higher dose (where dose=intensity*radiation time).

Examples of suitable B vitamins include riboflavin (vitamin B2), pantothenic acid (vitamin B5), pyridoxine (one form of vitamin B6), pyridoxamine (another form of vitamin B6), biotin (vitamin B7), folic acid (synthetic form of vitamin B9), cyanocobalamin (synthetic form of vitamin B12), and combinations thereof. Examples of suitable B vitamin derivatives include flavin mononucleotide, pyridoxal phosphate hydrate, pyridoxal hydrochloride, pyridoxine hydrochloride, and combinations thereof. Any combination of one or more B vitamins and one or more B vitamin derivatives may also be used. This may be desirable, for example, when one vitamin or vitamin derivative is less absorbing.

The amount of the B vitamin and/or B vitamin derivative present in the UV light fusing agent will depend, in part, upon its solubility in water and its effect on the jettability of the fusing agent. When solubility limit of the B vitamin and/or B vitamin derivative is low, the B vitamin and/or B vitamin derivative may be present in an amount ranging from about 1 wt % active to about 5 wt % active of the total weight of the fusing agent. For example, when the B vitamin or the B vitamin derivative is selected from the group consisting of riboflavin (solubility in water 1000 mg/3,000-15,000 mL depending on the crystal structure), folic acid (solubility in water 0.01 mg/mL), cyanocobalamin (solubility in water 1000 mg/80 mL), panthotenic acid (solubility in water 2110 mg/mL), biotin (solubility in water 0.22 mg/mL), pyridoxine (solubility in water ranging from 79 mg/mL to 220 mg/mL), and combinations thereof, the B vitamin or the B vitamin derivative is present in an amount ranging from about 1 wt % active to about 5 wt % active based on a total weight of the UV light fusing agent. When solubility limit of the B vitamin and/or B vitamin derivative is higher, the B vitamin and/or B vitamin derivative may be present in an amount ranging from about 1 wt % active to about 8 wt % active of the total weight of the fusing agent. For example, when the B vitamin or the B vitamin derivative is selected from the group consisting pyridoxal phosphate hydrate (solubility in water 5.7 mg/mL), pyridoxal hydrochloride (solubility in water 11.7 mg/mL), pyridoxine hydrochloride (solubility in water 200 mg/mL), pyridoxamine (solubility in water 29 mg/mL), and combinations thereof, the B vitamin or the B vitamin derivative may be present in an amount ranging from about 1 wt % active to about 8 wt % active based on a total weight of the UV light fusing agent.

Another example of UV energy absorber is a functionalized benzophenone. Some of the functionalized benzophenoneo have absorption at wavelengths ranging from about 340 nm to 405 nm. The phrase “have absorption at wavelengths ranging from about 340 nm to about 405 nm” means that the functionalized benzophenone exhibits maximum absorption at a wavelength within the given range and/or has an absorbance of about 0.1 (about 80% transmittance or less) at one or more wavelengths within the given range.

The functionalized benzophenone is benzophenone substituted with at least one hydrophilic functional group. The functionalilzation may render the substituted benzophenone more hydrophilic than benzophenone and/or may shift the absorption of the substituted benzophenone to the desired UV range (340 nm to 405 nm). As such, the functionalized benzophenone is a benzophenone derivative including at least one hydrophilic functional group. In some examples, the functionalized benzophenone is benzophenone substituted with one hydrophilic functional group. In other examples, the functionalized benzophenone is benzophenone substituted with two hydrophilic functional groups. In still other examples, the functionalized benzophenone is benzophenone substituted with three hydrophilic functional groups. In the examples where the benzophenone is substituted with multiple functional groups, these groups may be the same or different. Examples of the hydrophilic functional group may be selected from the group consisting of an amine group, a hydroxy group, an alkoxy group, a carboxylic acid group, or a sulfonic acid group.

In examples where the at least one hydrophilic functional group is the amine group, the functionalized benzophenone is selected from the group consisting of 4-aminobenzophenone:

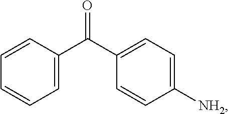 [SMILES: Nc1ccc(C(=O)c2ccccc2)cc1]

4-dimethylaminobenzophenone:

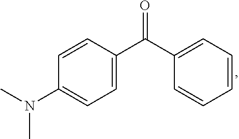 [SMILES: CN(C)c1ccc(C(=O)c2ccccc2)cc1]

and combinations thereof.

In examples where the at least one hydrophilic functional group is the hydroxy group, the functionalized benzophenone is selected from the group consisting are 4-hydroxy-benzophenone:

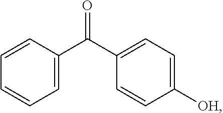 [SMILES: O=C(c1ccccc1)c1ccc(O)cc1]

2,4-dihydroxy-benzophenone:

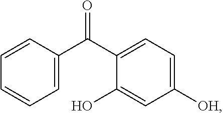 [SMILES: O=C(c1ccccc1)c1ccc(O)cc1O]

4,4-dihydroxy-benzophenone:

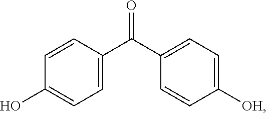 [SMILES: O=C(c1ccc(O)cc1)c1ccc(O)cc1]

2,4,4′-trihydroxy-benzophenone:

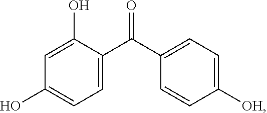 [SMILES: O=C(c1ccc(O)cc1)c1ccc(O)cc1O]

2,4,6-trihydroxy-benzophenone:

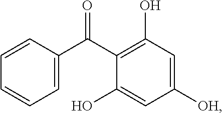 [SMILES: O=C(c1ccccc1)c1c(O)cc(O)cc1O]

2,2′,4,4′-tetrahydroxy-benzophenone:

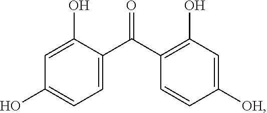 [SMILES: O=C(c1ccc(O)cc1O)c1ccc(O)cc1O]

2,3,4-trihydroxy-benzophenone:

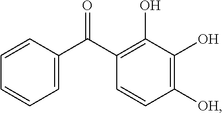 [SMILES: O=C(c1ccccc1)c1ccc(O)c(O)c1O]

2,3,4,4′-tetrahydroxy-benzophenone:

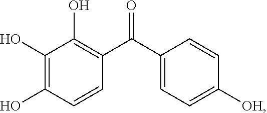 [SMILES: O=C(c1ccc(O)cc1)c1ccc(O)c(O)c1O]

and combinations thereof.

In examples where the at least one hydrophilic functional group is the alkoxy group, the functionalized benzophenone is 4,4′-dimethoxybenophenone:

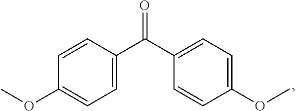

In other examples, the functionalized benzophenone may contain hydrophilic functional groups that are different. In these examples, the functionalized benzophenone is a benzophenone derivative including at least two different hydrophilic functional groups.

In one example, a first hydrophilic functional group of the at least two different hydrophilic functional groups is an alkoxy group, and a second hydrophilic functional group of the at least two different hydrophilic functional groups is a hydroxyl group. Some examples of these functionalized benzophenones include 2-hydroxy-4-dodecyloxy-benzophenone:

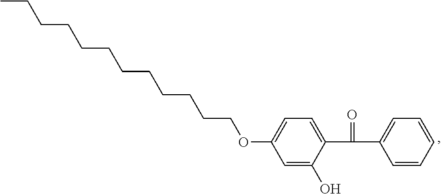 [SMILES: CCCCCCCCCCCCOc1ccc(C(=O)c2ccccc2)c(O)c1]

2-hydroxy-4-methoxy-benzophenone:

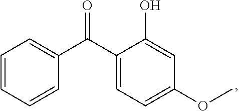 [SMILES: COc1ccc(C(=O)c2ccccc2)c(O)c1]

2,2′-hydroxy-4-methoxy-benzophenone:

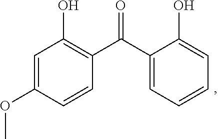 [SMILES: COc1ccc(C(=O)c2ccccc2O)c(O)c1]

and combinations thereof.

In another example, a first hydrophilic functional group of the at least two different hydrophilic functional groups may be selected from the group consisting of a hydroxy group and a carboxylic acid group, and a second hydrophilic functional group of the at least two different hydrophilic functional groups is an alkyl group. Some examples of these functionalized benzophenones include 2-hydroxy-4-methyl-benzophenone:

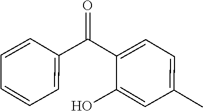 [SMILES: Cc1ccc(C(=O)c2ccccc2)c(O)c1]

and 4′-Methylbenzo-phenone-2-carboxylic acid:

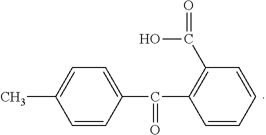 [SMILES: Cc1ccc(C(=O)c2ccccc2C(=O)O)cc1]

In yet another example, a first hydrophilic functional group of the at least two different hydrophilic functional groups is a hydroxy group, a second hydrophilic functional group of the at least two different hydrophilic functional groups is an alkoxy group, and a third hydrophilic functional group of the at least two different hydrophilic functional groups is a sulfonic acid group. An example of this functionalized benzophenone is 2-hydroxy-4-methoxy-benzophenone-5-sulfonic acid.

Examples of the functionalized benzophenones include 4-hydroxy-benzophenone, 2,4-dihydroxy-benzophenone, 4,4 dihydroxy-benzophenone, 2,4,4′-trihydroxy-benzophenone, 2,4,6 trihydroxy-benzophenone, 2,2′,4,4′-tetrahydroxy-benzophenone, 4,4′-dimethoxybenzophenone, 4-aminobenzophenone, 4-dimethylamino-benzophenone, 2-hydroxy-4-methyl-benzophenone, 4′-methylbenzo-phenone-2-carboxylic acid, 2-hydroxy-4-dodecyloxy-benzophenone, 2-hydroxy-4-methoxy-benzophenone, 2-hydroxy-4-methoxy-benzophenone-5-sulfonic acid, 2,3,4-trihydroxy-benzophenone, 2,3,4,4′-tetrahydroxy-benzophenone, 2,2′-hydroxy-4-methoxy-benzophenone, and combinations thereof.

While several examples of functionalized benzophenones have been provided herein, it is to be understood that any benzophenone substituted with at least one hydrophilic functional group may be used. These may be naturally occurring or synthesized. As examples, benzophenone derivatives with at least one poly(ethylene glycol) (PEG) chain or with at least one phosphocholine chain may be synthesized.

The functionalized benzophenone is at least partially soluble in an aqueous vehicle of the fusing agent. The phrase “at least partially soluble” means that at least 0.5 wt % of the functionalized benzophenone is able to dissolve in the aqueous vehicle.

The amount of the functionalized benzophenone present in the UV light fusing agent will depend, in part, upon its solubility in the aqueous vehicle and its effect on the jettability of the fusing agent. The functionalized benzophenone may be present in an amount ranging from about 0.01 wt % active to about 10 wt % active of the total weight of the fusing agent. When the solubility limit of the functionalized benzophenone in the aqueous vehicle is low (e.g., is less than 5 wt % soluble), the functionalized benzophenone may be present in an amount ranging from about 0.01 wt % active to about 5 wt % active of the total weight of the fusing agent. In an example, the functionalized benzophenone may be present in an amount ranging from about 2 wt % active to about 4 wt % active of the total weight of the fusing agent.

Still another example of UV energy absorber is a plasmonic metal nanoparticle that i) provides absorption enhancement at radiation wavelengths ranging from about 340 nm to about 450 nm, and ii) is present in an amount up to 2 wt % active based on a total weight of the UV light fusing agent.

In an example, the plasmonic metal nanoparticle is selected from the group consisting of silver nanoparticles, gold nanoparticles, copper nanoparticles, aluminum nanoparticles, and combinations thereof. The example plasmonic metal nanoparticles do not merely absorb the UV in the selected range, they exhibit enhanced absorption caused by localized surface plasmon resonance in the near UV and the high photon energy end of visible range (range 340-450 nm). The phrase “absorbs radiation at wavelengths ranging from about 340 nm to about 450 nm” means that the plasmonic metal nanoparticle exhibits maximum absorption at a wavelength within the given range and/or has an absorbance greater than 1 (about 10% transmittance or less) at one or more wavelengths within the given range.

The plasmonic metal nanoparticle may have an average particle size ranging from about 1 nm to about 200 nm. In one example, the plasmonic metal nanoparticle has an average particle size ranging from about 1 nm to about 100 nm. In another example, the plasmonic metal nanoparticle has an average particle size ranging from about 1 nm to about 50 nm.

Yet another example of a suitable UV energy absorber is a fluorescent yellow dye having a targeted wavelength of maximum absorption for a 3D print system including the narrow UV-band emission source. The UV light absorber consists of the fluorescent yellow dye, without any other colorant. In particular, it would not be desirable to include any pigment or dye that absorbs other light, or any pigment that could crash out of solution when included with the fluorescent yellow dye.

The fluorescent yellow dye may be pyranine:

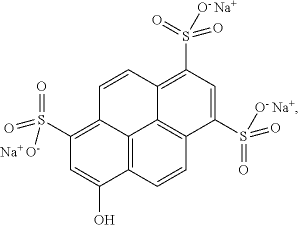

a pyranine derivative, coumarin:

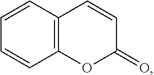 [SMILES: O=c1ccc2ccccc2o1]

a coumarin derivative, a naphthalimide:

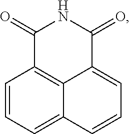 [SMILES: O=C1NC(=O)c2cccc3cccc1c23]

a naphthalimide derivative, a disazomethine derivative: RCH═N—N═CHR, or mixture of these compounds. Some specific examples include Solvent Green 7 (pyranine), Acid Yellow 184 (a coumarin derivative), Acid Yellow 250 (a coumarin derivative), Yellow 101 (Aldazine:

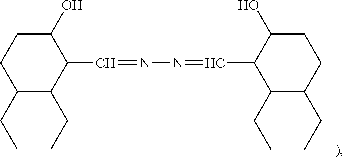

Basic Yellow 40 (a coumarin derivative), Solvent Yellow 43 (a naphthalimide derivative), Solvent Yellow 44 (a naphthalimide derivative), Solvent Yellow 85 (a naphthalimide derivative), Solvent Yellow 145 (a coumarin derivative), Solvent Yellow 160:1 (a coumarin derivative), and combinations thereof.

The fluorescent yellow dye may be present in the UV light fusing agent in an amount ranging from about 1 wt % active to about 10 wt % active, based on a total weight of the UV light fusing agent. In another example, the fluorescent yellow dye may be present in the fusing agent in an amount ranging from about 5 wt % active to about 8 wt % active, or from about 5.5 wt % active to about 7.5 wt % active.

### Fusing Agent Vehicle

Any example of the fusing agent (core fusing agent, primer fusing agent, UV light fusing agent) includes a liquid vehicle. The fusing agent vehicle, or “FA vehicle,” may refer to the liquid in which the energy absorber is/are dispersed or dissolved to form the respective fusing agent. A wide variety of FA vehicles, including aqueous and non-aqueous vehicles, may be used in the fusing agents. In some examples, the FA vehicle may include water alone or a non-aqueous solvent alone, i.e., with no other components. In other examples, the FA vehicle may include other components, depending, in part, upon the applicator that is to be used to dispense the fusing agent. Examples of other suitable fusing agent components include co-solvent(s), humectant(s), surfactant(s), anti-microbial agent(s), anti-kogation agent(s), chelating agent(s), buffer(s), pH adjuster(s), preservative(s), and/or combinations thereof.

Classes of water soluble or water miscible organic co-solvents that may be used in the fusing agents include aliphatic alcohols, aromatic alcohols, diols, glycol ethers, polyglycol ethers, lactams, formamides (substituted and unsubstituted), acetamides (substituted and unsubstituted), glycols, and long chain alcohols. Examples of these co-solvents include primary aliphatic alcohols, secondary aliphatic alcohols, 1,2-alcohols (e.g., 1,2-ethanediol, 1,2-propanediol, etc.), 1,3-alcohols (e.g., 1,3-propanediol), 1,5-alcohols (e.g., 1,5-pentanediol), 1,6-hexanediol or other diols (e.g., 2-methyl-1,3-propanediol, etc.), ethylene glycol alkyl ethers, propylene glycol, propylene glycol alkyl ethers, higher homologs (C₆-C₁₂) of polyethylene glycol alkyl ethers, diethylene glycol, triethylene glycol, tripropylene glycol methyl ether, tetraethylene glycol, glycerol, N-alkyl caprolactams, unsubstituted caprolactams, 2-pyrrolidone, 1-methyl-2-pyrrolidone, 1-(2-hydroxyethyl)-2-pyrrolidone, and the like. Other examples of organic co-solvents include dimethyl sulfoxide (DMSO), isopropyl alcohol, ethanol, pentanol, acetone, or the like.

The co-solvent(s) may be present in the fusing agent in a total amount ranging from about 1 wt % active to about 20 wt % active based upon the total weight of the fusing agent. In an example, the fusing agent includes from about 2 wt % active to about 15 wt % active, or from about 5 wt % active to about 10 wt % active of the co-solvent(s).

The FA vehicle may also include humectant(s). An example of a suitable humectant is ethoxylated glycerin having the following formula:

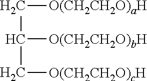

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

In an example, the total amount of the humectant(s) present in the fusing agent ranges from about 3 wt % active to about 10 wt % active, based on the total weight of the fusing agent.

The FA vehicle may also include surfactant(s). Suitable surfactant(s) include non-ionic or anionic surfactants. Some example surfactants include alcohol ethoxylates, alcohol ethoxysulfates, acetylenic diols, alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, fluorosurfactants, and the like. Some specific examples of non-ionic surfactants include the following from Evonik Degussa: SURFYNOL® SEF (a self-emulsifiable, wetting agent based on acetylenic diol chemistry), SURFYNOL® 440 or SURFYNOL® CT-111 (non-ionic ethoxylated low-foam wetting agents), SURFYNOL® 420 (non-ionic ethoxylated wetting agent and molecular defoamer), SURFYNOL® 104E (non-ionic wetting agents and molecular defoamer), and TEGO® Wet 510 (organic surfactant). Other specific examples of non-ionic surfactants include the following from The Dow Chemical Company: TERGITOL™ TMN-6, TERGITOL™ 15-S-7, TERGITOL™ 15-S-9, TERGITOL™ 15-S-12 (secondary alcohol ethoxylates). Other suitable non-ionic surfactants are available from Chemours, including the CAPSTONE® fluorosurfactants, such as CAPSTONE® FS-35 (a non-ionic fluorosurfactant). Some specific examples of anionic surfactants include alkyldiphenyloxide disulfonate (e.g., the DOWFAX™ series, such a 2A1, 3B2, 8390, C6L, C10L, and 30599, from The Dow Chemical Company), docusate sodium (i.e., dioctyl sodium sulfosuccinate), sodium dodecyl sulfate (SDS).

Whether a single surfactant is used or a combination of surfactants is used, the total amount of surfactant(s) in the fusing agent may range from about 0.01 wt % active to about 3 wt % active based on the total weight of the fusing agent. In an example, the total amount of surfactant(s) in the fusing agent may be about 1 wt % active based on the total weight of the build material reactive functional agent.

The FA vehicle may also include anti-microbial agent(s). Anti-microbial agents are also known as biocides and/or fungicides. Examples of suitable anti-microbial agents include the NUOSEPT® (Ashland Inc.), UCARCIDE™ or KORDEK™ or ROCIMA™ (The Dow Chemical Company), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (The Dow Chemical Company), and combinations thereof.

In an example, the total amount of anti-microbial agent(s) in the fusing agent ranges from about 0.01 wt % active to about 0.05 wt % active (based on the total weight of the fusing agent). In another example, the total amount of anti-microbial agent(s) in the fusing agent is about 0.04 wt % active (based on the total weight of the fusing agent).

The FA vehicle may also include anti-kogation agent(s) that is/are to be jetted using thermal inkjet printing. Kogation refers to the deposit of dried printing liquid (e.g., fusing agent) on a heating element of a thermal inkjet printhead. Anti-kogation agent(s) is/are included to assist in preventing the buildup of kogation.

Examples of suitable anti-kogation agents include oleth-3-phosphate (commercially available as CRODAFOS™ 03A or CRODAFOS™ N-3A) or dextran 500 k. Other suitable examples of the anti-kogation agents include CRODAFOS™ HCE (phosphate-ester from Croda Int.), CRODAFOS® 010A (oleth-10-phosphate from Croda Int.), or DISPERSOGEN® LFH (polymeric dispersing agent with aromatic anchoring groups, acid form, anionic, from Clariant), etc. It is to be understood that any combination of the anti-kogation agents listed may be used.

The anti-kogation agent may be present in the fusing agent in an amount ranging from about 0.1 wt % active to about 1.5 wt % active, based on the total weight of the fusing agent. In an example, the anti-kogation agent is present in an amount of about 0.5 wt % active, based on the total weight of the fusing agent.

Chelating agents (or sequestering agents) may be included in the liquid vehicle of the fusing agent to eliminate the deleterious effects of heavy metal impurities. In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

Whether a single chelating agent is used or a combination of chelating agents is used, the total amount of chelating agent(s) in the fusing agent may range from greater than 0 wt % active to about 0.5 wt % active based on the total weight of the fusing agent. In an example, the chelating agent is present in an amount ranging from about 0.05 wt % active to about 0.2 wt % active based on the total weight of fusing agent. In another example, the chelating agent(s) is/are present in the fusing agent in an amount of about 0.05 wt % active (based on the total weight of the fusing agent).

Some examples of the fusing agent include a buffer. The buffer may be TRIS (tris(hydroxymethyl)aminomethane or TRIZMA®), TRIS or TRIZMA® hydrochloride, bis-tris propane, TES (2-[(2-Hydroxy-1,1-bis(hydroxymethyl)ethyl)amino]ethanesulfonic acid), MES (2-ethanesulfonic acid), MOPS (3-(N-morpholino)propanesulfonic acid), HEPES (4-(2-hydroxyethyl)-1-piperazineethanesulfonic acid), DIPSO (3-(N,N-Bis[2-hydroxyethyl]amino)-2-hydroxypropanesulfonic acid), Tricine (N-[tris(hydroxymethyl)methyl]glycine), HEPPSO (β-Hydroxy-4-(2-hydroxyethyl)-1-piperazinepropanesulfonic acid monohydrate), POPSO (Piperazine-1,4-bis(2-hydroxypropanesulfonic acid) dihydrate), EPPS (4-(2-Hydroxyethyl)-1-piperazinepropanesulfonic acid, 4-(2-Hydroxyethyl)piperazine-1-propanesulfonic acid), TEA (triethanolamine buffer solution), Gly-Gly (Diglycine), bicine (N,N-Bis(2-hydroxyethyl)glycine), HEPBS (N-(2-Hydroxyethyl)piperazine-N′-(4-butanesulfonic acid)), TAPS ([tris(hydroxymethyl)methylamino]propanesulfonic acid), AMPD (2-amino-2-methyl-1,3-propanediol), TABS (N-tris(Hydroxymethyl)methyl-4-aminobutanesulfonic acid), or the like.

In an example, the total amount of buffer(s) in the fusing agent ranges from about 0.01 wt % to about 3 wt % (based on the total weight of the fusing agent).

Some examples of the fusing agent include a pH adjuster. Suitable pH adjusters may include amino acids or sodium bicarbonate. An example of a suitable amino acid pH adjuster is taurine. In an example, the total amount of the pH adjuster(s) in the fusing agent ranges from about 0.01 wt % to about 3 wt % (based on the total weight of the fusing agent).

Some examples of the fusing agent include a preservative. Preservatives may be particular suitable when vitamin B or a vitamin B derivative is used as the energy absorber. Examples of suitable preservatives include 2-phenoxyethanol, sodium benzoate, and parabens. In an example, the total amount of the preservative(s) in the fusing agent ranges from about 0.1 wt % to about 3 wt % (based on the total weight of the UV light fusing agent).

Some examples of the fusing agent, particularly the UV light fusing agent, also include a base. In some examples, the B vitamin or the B vitamin derivative is more soluble at a neutral or basic pH. For example, folic acid is more soluble in an aqueous vehicle having a pH greater than 5. As such, it may be desirable to add a base, such as potassium hydroxide, sodium hydroxide, or tetramethylammonium hydroxide, until the desired pH is obtained. In an example, the total amount of the base in the fusing agent ranges from about 0.5 wt % to about 5 wt % (based on the total weight of the fusing agent). In other examples, the amount of base may range from about 0.75 wt % to about 2.5 wt %.

The balance of the fusing agent is water (e.g., deionized water, purified water, etc.). The amount of water may vary depending upon the amounts of the other components in the fusing agent. In one example, the fusing agent is jettable via a thermal inkjet printhead, and includes from about 50 wt % to about 90 wt % water.

### Detailing Agent

The 3D manufacturing method that involves the selective application of the fusing agent to pattern the layer of the build material composition may also involve the selective application of a detailing agent. The detailing agent does not include an energy absorber, and may be applied to portion(s) of the build material composition that are outside of the 3D object model. The portion(s) of the build material composition exposed to the detailing agent may experience a cooling effect, and thus the detailing agent helps to keep the portion(s) from coalescing.

The detailing agent may include a surfactant, a co-solvent, and a balance of water. In some examples, the detailing agent consists of these components, and no other components. In some other examples, the detailing agent may further include a colorant. In still some other examples, the detailing agent consists of a colorant, a surfactant, a co-solvent, and a balance of water, with no other components. In yet some other examples, the detailing agent may further include additional components, such as anti-kogation agent(s), anti-microbial agent(s), and/or chelating agent(s) (each of which is described above in reference to the fusing agent).

The surfactant(s) that may be used in the detailing agent include any of the surfactants listed herein in reference to the fusing agent. The total amount of surfactant(s) in the detailing agent may range from about 0.10 wt % active to about 5.00 wt % active with respect to the total weight of the detailing agent.

The co-solvent(s) that may be used in the detailing agent include any of the co-solvents listed above in reference to the fusing agent. The total amount of co-solvent(s) in the detailing agent may range from about 1 wt % active to about 65 wt % active with respect to the total weight of the detailing agent.

In some examples, the detailing agent does not include a colorant. In these examples, the detailing agent may be colorless. As used herein, “colorless,” means that the detailing agent is achromatic and does not include a colorant. The colorless detailing agent may be used with any of the fusing agents disclosed herein.

In other examples, the detailing agent does include a colorant. It may be desirable to add color to the detailing agent when the detailing agent is applied to the edge of a colored 3D object, such as an object formed using the core fusing agent. Color in the detailing agent may be desirable when used at a part edge because some of the colorant may become embedded in the build material composition that fuses/coalesces at the edge. As such, in some examples, the dye in the detailing agent may be selected so that its color matches the color of the energy absorber in the fusing agent. As examples, the dye may be any azo dye having sodium or potassium counter ion(s) or any diazo (i.e., double azo) dye having sodium or potassium counter ion(s), where the color of azo or dye azo dye matches the color of the fusing agent.

When the detailing agent includes the colorant and is to be used with the core fusing agent, the colorant may be a dye of any color having substantially no absorbance in a range of 650 nm to 2500 nm. By “substantially no absorbance” it is meant that the dye absorbs no radiation having wavelengths in a range of 650 nm to 2500 nm, or that the dye absorbs less than 10% of radiation having wavelengths in a range of 650 nm to 2500 nm. The dye may also be capable of absorbing radiation with wavelengths of 650 nm or less. As such, the dye absorbs at least some wavelengths within the visible spectrum, but absorbs little or no wavelengths within the near-infrared spectrum. This is in contrast to the energy absorber in the core fusing agent, which absorbs wavelengths within the near-infrared spectrum. As such, the colorant in the detailing agent will not substantiallly absorb the fusing radiation, and thus will not initiate melting and fusing (coalescence) of the build material composition in contact therewith when the build material layer is exposed to the energy.

In an example, the dye is a black dye. Some examples of the black dye include azo dyes having sodium or potassium counter ion(s) and diazo (i.e., double azo) dyes having sodium or potassium counter ion(s). Examples of azo and diazo dyes may include tetrasodium (6Z)-4-acetamido-5-oxo-6-[[7-sulfonato-4-(4-sulfonatophenyl)azo-1-naphthyl]hydrazono]naphthalene-1,7-disulfonate with a chemical structure of:

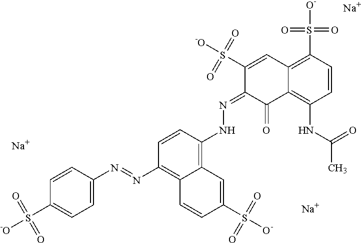

(commercially available as Food Black 1); tetrasodium 6-amino-4-hydroxy-3-[[7-sulfonato-4-[(4-sulfonatophenyl)azo]-1-naphthyl]azo]naphthalene-2,7-disulfonate with a chemical structure of:

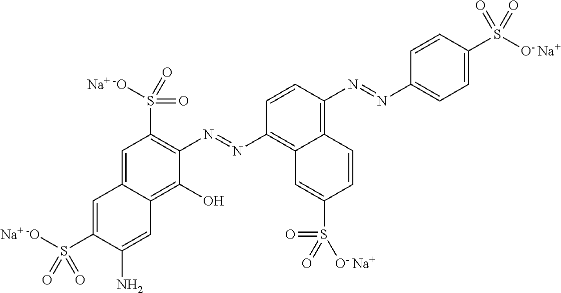

(commercially available as Food Black 2); tetrasodium (6E)-4-amino-5-oxo-3-[[4-(2-sulfonatooxyethylsulfonyl)phenyl]diazenyl]-6-[[4-(2-sulfonatooxyethylsulfonyl)phenyl]hydrazinylidene]naphthalene-2,7-disulfonate with a chemical structure of:

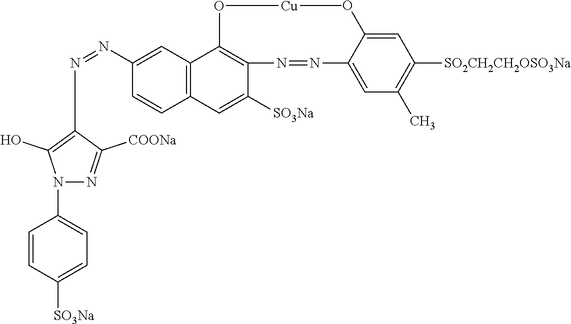

(commercially available as Reactive Black 31); tetrasodium (6E)-4-amino-5-oxo-3-[[4-(2-sulfonatooxyethylsulfonyl)phenyl]diazenyl]-6-[[4-(2-sulfonatooxyethylsulfonyl)phenyl]hydrazinylidene]naphthalene-2,7-disulfonate with a chemical structure of:

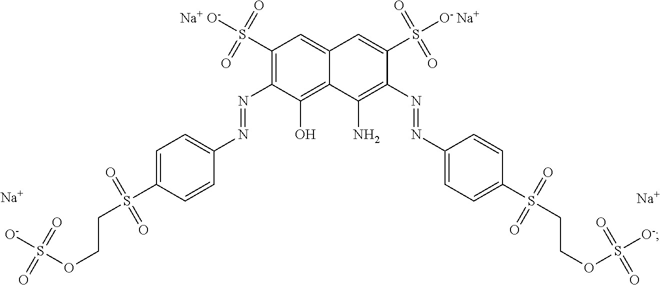

and combinations thereof. Some other commercially available examples of the dye used in the detailing agent include multipurpose black azo-dye based liquids, such as PRO-JET® Fast Black 1 (made available by Fujifilm Holdings), and black azo-dye based liquids with enhanced water fastness, such as PRO-JET® Fast Black 2 (made available by Fujifilm Holdings).

In some instances, in addition to the black dye, the colorant in the detailing agent may further include another dye. In an example, the other dye may be a cyan dye that is used in combination with any of the dyes disclosed herein. The other dye may also have substantially no absorbance above 650 nm. The other dye may be any colored dye that contributes to improving the hue and color uniformity of the final 3D printed polyamide object.

Some examples of the other dye include a salt, such as a sodium salt, an ammonium salt, or a potassium salt. Some specific examples include ethyl-[4-[[4-[ethyl-[(3-sulfophenyl) methyl]amino]phenyl]-(2-sulfophenyl) ethylidene]-1-cyclohexa-2,5-dienylidene]-[(3-sulfophenyl) methyl]azanium with a chemical structure of:

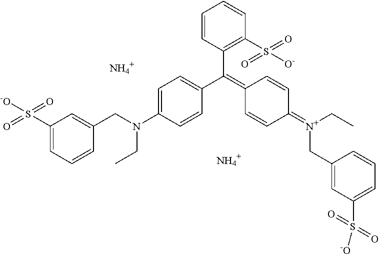

(commercially available as Acid Blue 9, where the counter ion may alternatively be sodium counter ions or potassium counter ions); sodium 4-[(E)-{4-[benzyl(ethyl)amino]phenyl}{(4E)-4-[benzyl(ethyl)iminio]cyclohexa-2,5-dien-1-ylidene}methyl]benzene-1,3-disulfonate with a chemical structure of:

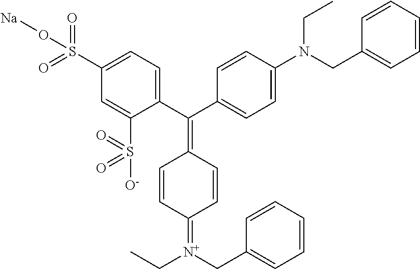

(commercially available as Acid Blue 7); and a phthalocyanine with a chemical structure of:

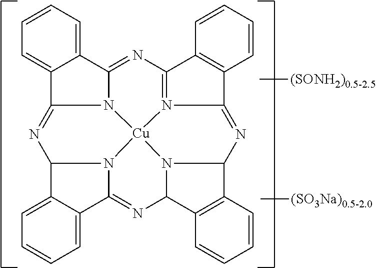

(commercially available as Direct Blue 199); and combinations thereof.

In an example of the detailing agent, the dye may be present in an amount ranging from about 1 wt % active to about 3 wt % active based on the total weight of the detailing agent. In another example of the detailing agent including a combination of dyes, one dye (e.g., the black dye) is present in an amount ranging from about 1.50 wt % active to about 1.75 wt % active based on the total weight of the detailing agent, and the other dye (e.g., the cyan dye) is present in an amount ranging from about 0.25 wt % active to about 0.50 wt % active based on the total weight of the detailing agent.

The balance of the detailing agent is water. As such, the amount of water may vary depending upon the amounts of the other components that are included.

### Coloring Agent

The 3D manufacturing method that involves the selective application of the fusing agent to pattern the layer of the build material composition may also involve the selective application of a coloring agent. The coloring agent may be used to impart color to the 3D object.

In these examples, the coloring agent is separate from the fusing agent. A coloring agent separate from the fusing agent may be desirable because the two agents can be applied separately, thus allowing control over where color is added. The coloring agent may be applied during printing (e.g., on the build material composition with the fusing agent) or after printing (e.g., on a 3D printed object) to impart a colored appearance to the 3D printed object.

The coloring agent may include a colorant, a co-solvent, and a balance of water. In some examples, the coloring agent of these components, and no other components. In still other examples, the coloring agent may further include additional components that aid in colorant dispersability and/or ink jettability. Some examples of additional coloring agent components include dispersant(s) (e.g., a water-soluble acrylic acid polymer (e.g., CARBOSPERSE® K7028 available from Lubrizol), water-soluble styrene-acrylic acid copolymers/resins (e.g., JONCRYL® 296, JONCRYL®671, JONCRYL® 678, JONCRYL® 680, JONCRYL® 683, JONCRYL® 690, etc. available from BASF Corp.), a high molecular weight block copolymer with pigment affinic groups (e.g., DISPERBYK®-190 available BYK Additives and Instruments), or water-soluble styrene-maleic anhydride copolymers/resins), humectant(s), surfactant(s), anti-kogation agent(s), and/or antimicrobial agent(s) (examples of which are described herein in reference to the fusing agent).

The coloring agent may be a black agent, a cyan agent, a magenta agent, or a yellow agent. As such, the colorant may be a black colorant, a cyan colorant, a magenta colorant, a yellow colorant, or a combination of colorants that together achieve a black, cyan, magenta, or yellow color. While some examples have been provided, it is to be understood that other colored inks may also be used.

The colorant of the coloring agent may be any pigment or dye. When the coloring agent is a separate agent, the pigment or dye is to impart color, and is not meant to replace the energy absorber in the fusing agent. As such, the colorant may function as an energy absorber or as a partial energy absorber, or may not provide any anergy absorption.

An example of the pigment based colored ink may include from about 1 wt % to about 10 wt % of pigment(s), from about 10 wt % to about 30 wt % of co-solvent(s), from about 1 wt % to about 10 wt % of dispersant(s), 0.01 wt % to about 1 wt % of anti-kogation agent(s), from about 0.05 wt % to about 0.1 wt % anti-microbial agent(s), and a balance of water. An example of the dye based colored ink may include from about 1 wt % to about 7 wt % of dye(s), from about 10 wt % to about 30 wt % of co-solvent(s), from about 1 wt % to about 7 wt % of dispersant(s), from about 0.05 wt % to about 0.1 wt % antimicrobial agent(s), from 0.05 wt % to about 0.1 wt % of chelating agent(s), from about 0.005 wt % to about 0.2 wt % of buffer(s), and a balance of water.

### Sets and Kits

The build material composition disclosed herein may be part of a 3D printing kit with any example of the fusing agent (e.g., core, primer, and/or UV light) disclosed herein. In one example, the kit is a single fusing agent kit that includes the build material composition and one of the fusing agents (e.g., the core fusing agent, the primer fusing agent, or the UV light fusing agent). In one example, the kit is a multi-fusing agent kit that includes the build material composition and two or more of the fusing agents (e.g., the core fusing agent and the primer fusing agent).

Any example of the 3D printing kit may also be a multi-fluid kit, which includes one or more of the fusing agents, as well as the detailing agent and/or the coloring agent.

It is to be understood that the fluid(s) and the build material composition of the 3D printing kits may be maintained separately until used together in examples of the 3D printing method disclosed herein. The fluid(s) and/or compositions may each be contained in one or more containers prior to and during printing, but may be combined together during printing. The containers can be any type of a vessel (e.g., a reservoir), box, or receptacle made of any material.

### Printing Methods

The build material composition disclosed herein may be used in a variety of 3D printing techniques, including those that utilize a fusing agent or selective laser sintering (SLS). The 3D printing method generally includes spreading a build material composition to form a build material layer, the build material composition including polyamide particles present in an amount of at least 82 wt % based on a total weight of the build material composition; and a filler material consisting of aramid fibers having an average aspect ratio ranging from about 0.1 mm/20 μm to about 1.2 mm/16 μm, the aramid fibers present in an amount ranging from about 2 wt % to about 18 wt % based on the total weight of the build material composition; and coalescing at least some of the build material composition in the build material layer by: i) based on a 3D object model, selectively applying a fusing agent on at least a portion of the build material layer, and exposing the build material layer to electromagnetic radiation to coalesce the build material composition in the at least the portion, thereby forming a layer of a 3D object; or ii) based on a 3D object model, selectively exposing the at least some of the build material composition in the build material layer to a laser beam.

To form the 3D object, the method may be repeated. As such, the method may further include iteratively applying individual build material layers of the build material composition, and iteratively coalescing at least some of the build material composition in each of the build material layers.

An example of the 3D object (i.e., 3D printed article) disclosed herein includes coalesced build material, which includes polyamide particles present in an amount of at least 80 wt % based on a total weight of the 3D printed article; and a filler material consisting of aramid fibers having an average aspect ratio ranging from about 0.1 mm/20 μm to about 1.2 mm/16 μm, the aramid fibers present in an amount ranging from about 1 wt % to about 18 wt % based on the total weight of the 3D printed article.

Some examples of the 3D printed article also include the flow aid present in an amount up to 0.2 wt % based on the total weight of the 3D printed article, and/or any other build material composition additives set forth herein.

When the 3D printing technique utilized to generate the 3D printed article involves the selective application of the fusing agent, the 3D printed article also includes an energy absorber intermingled with the coalesced build material, wherein the energy absorber: exhibits absorption at least at some wavelengths within a range of from 100 nm to 4000 nm; or exhibits absorption at wavelengths ranging from 100 nm to 400 nm or 800 nm to 4000 nm and has transparency at wavelengths ranging from 400 nm to 780 nm. The amount of the energy absorber in the 3D printed article will depend upon the amount of the energy absorber in the fusing agent as well as the volume of the fusing agent that is applied to each of the layers of the build material composition.

The 3D printed article may also include the coloring agent applied on an exterior of the 3D printed article or incorporated into at least a portion of the coalesced build material, the coloring agent being selected from the group consisting of a black agent, a cyan agent, a magenta agent, and a yellow agent.

Printing Methods with Fusing Agent(s)

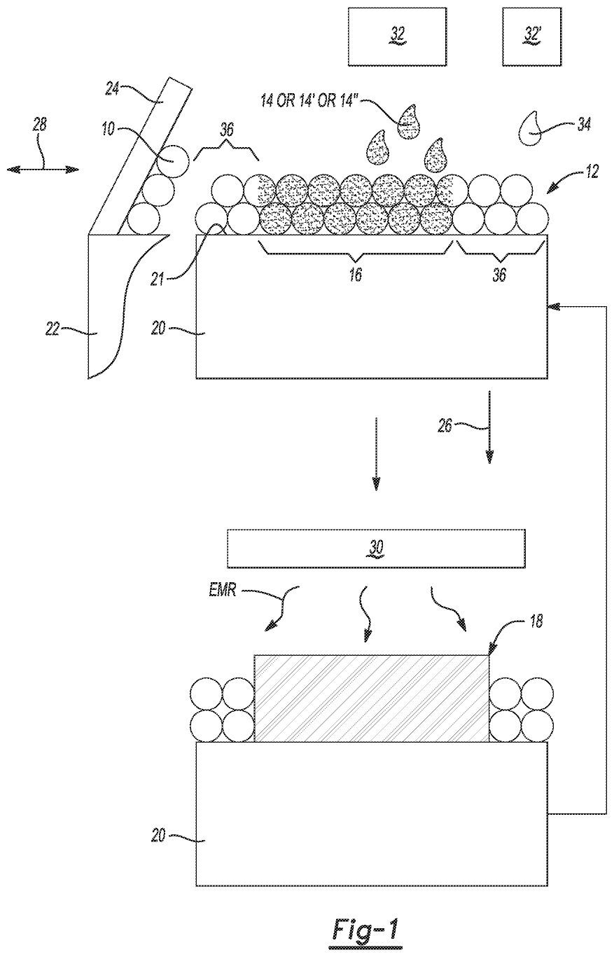

Different examples of the 3D printing method that utilize the fusing agent(s) are shown and described in reference to FIG. 1 through FIG. 4.

Prior to execution of any examples of the method, it is to be understood that a controller may access data stored in a data store pertaining to a 3D part/object that is to be printed. The data may include a digital model of the 3D part/object that is to be build, and additional data, for example, the number of layers of the build material composition that are to be formed, the locations at which any of the agents is/are to be deposited on each of the respective layers, etc. may be derived from this digital 3D object model.

Printing with one Fusing Agent

Referring now to FIG. 1, an example of a 3D printing method which utilizes one of the fusing agents is schematically depicted.

The method shown in FIG. 1 includes spreading the build material composition 10 to form a build material layer 12; based on a 3D object model, selectively applying a fusing agent (e.g., core fusing agent 14, primer fusing agent 14′, UV light fusing agent 14″) onto the build material layer 12, thereby forming a patterned portion 16; and exposing the build material layer 12 to electromagnetic radiation EMR to selectively coalesce the patterned portion 16 and form a 3D printed object layer 18.

Prior to spreading, the method may further include applying the build material composition 10 to a build area platform 20 having an X-Y plane (at surface 21). In FIG. 1, the layer 12 of the build material composition 10 is formed on the build area platform 20. A printing system may be used to apply the build material composition 10. The printing system may include the build area platform 20, a build material supply 22 containing the build material composition 10, and a build material distributor 24.

The surface 21 of the build area platform 20 provides the X-Y plane for building the 3D printed object. The surface 21 receives the build material composition 10 from the build material supply 22. The build area platform 20 may be moved in the directions as denoted by the arrow 26, e.g., along the Z-axis, so that the build material composition 10 may be delivered to the build area platform 20 or to a previously formed layer. In an example, when the build material composition 10 is to be delivered, the build area platform 20 may be programmed to advance (e.g., downward) enough so that the build material distributor 24 can push the build material composition 10 onto the build area platform 20 to form a substantially uniform layer 12 of the build material composition 10 thereon. The build area platform 20 may also be returned to its original position, for example, when a new part is to be built.

The build material supply 22 may be a container, bed, or other surface that is to position the build material composition 10 between the build material distributor 24 and the build area platform 20. The build material supply 22 may include heaters so that the build material composition 10 is heated to a supply temperature ranging from about 25° C. to about 150° C. In these examples, the supply temperature may depend, in part, on the build material composition 10 used and/or the 3D printer used. As such, the range provided is one example, and higher or lower temperatures may be used.

The build material distributor 24 may be moved in the directions as denoted by the arrow 28, e.g., along the Y-axis, over the build material supply 22 and across the build area platform 20 to spread the layer 12 of the build material composition 10 over the build area platform 20. In this example, the spreading is performed in the Y-direction of the X-Y plane. The build material distributor 24 may also be returned to a position adjacent to the build material supply 22 following the spreading of the build material composition 10. The build material distributor 24 may be a blade (e.g., a doctor blade), a roller, a combination of a roller and a blade, and/or any other device capable of spreading the build material composition 10 over the build area platform 20. For instance, the build material distributor 24 may be a counter-rotating roller. In some examples, the build material supply 22 or a portion of the build material supply 22 may translate along with the build material distributor 24 such that build material composition 10 is delivered continuously to the build area platform 20 rather than being supplied from a single location at the side of the printing system as depicted in FIG. 1.

The build material supply 22 may supply the build material composition 10 into a position so that it is ready to be spread onto the build area platform 20. The build material distributor 24 may spread the supplied build material composition 10 onto the build area platform 20. The controller (not shown) may process “control build material supply” data, and in response, control the build material supply 22 to appropriately position the particles of the build material composition 10, and may process “control spreader” data, and in response, control the build material distributor 24 to spread the build material composition 10 over the build area platform 20 to form the layer 12. In FIG. 1, one build material layer 12 has been formed.

The layer 12 has a substantially uniform thickness across the build area platform 20. In an example, the build material layer 12 has a thickness ranging from about 50 μm to about 120 μm. In another example, the thickness of the build material layer 12 ranges from about 30 μm to about 300 μm. It is to be understood that thinner or thicker layers may also be used. For example, the thickness of the build material layer 12 may range from about 20 μm to about 500 μm. The layer thickness may be about 2× (i.e., 2 times) the average particle size (e.g., diameter) of the polyamide particles at a minimum for finer part definition. In some examples, the layer thickness may be about 1.2× the average diameter of the polyamide particles in the build material composition 10.

After the build material composition 10 has been applied and spread, and prior to further processing, the build material layer 12 may be exposed to heating. In an example, the heating temperature may be below the melting point of the polyamide particles in the build material composition 10. As examples, the pre-heating temperature may range from about 10° C. to about 150° C. below the melting point of the polyamide particles. In an example, the pre-heating temperature ranges from about 50° C. to about 170° C.

Pre-heating the layer 12 may be accomplished by using any suitable heat source that exposes all of the build material composition 10 in the layer 12 to the heat. Examples of the heat source include a thermal heat source (e.g., a heater (not shown) integrated into the build area platform 20 (which may include sidewalls)) or a radiation source 30.

After the layer 12 is formed, and in some instances is pre-heated, the fusing agent 14 or 14′ or 14″ is selectively applied on at least some of the build material composition 10 in the layer 12 to form a patterned portion 16.

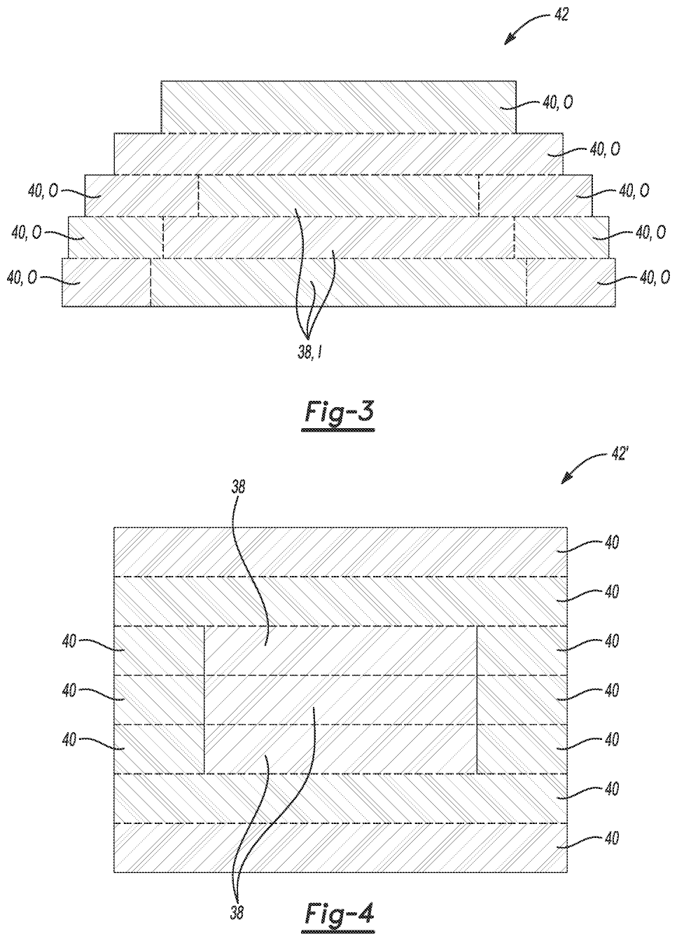

To form a layer 18 of a 3D printed object, at least a portion (e.g., patterned portion 16) of the layer 12 of the build material composition 10 is patterned with the fusing agent 14 or 14′ or 14″. Any of the core fusing agent 14, or the primer fusing agent 14′, or the UV light fusing agent 14″ may be used. When it is desirable to form a white, colored, or slightly tinted object layer 18, the primer fusing agent 14′ or the UV light fusing agent 14″ may be used to pattern the build material composition 10. The primer fusing agent 14′ or the UV light fusing agent 14″ is clear or slightly tinted (depending upon the energy absorber used), and thus the resulting 3D printed object layer 18 may appear white, lightly colored (e.g., yellow), or the color of the build material composition 10. When it is desirable to form a darker color or black object layer 18, the core fusing agent 14 may be used. The core fusing agent 14 is dark or black, and thus the resulting 3D printed object layer 18 may appear grey, black or another dark color. In other examples of the method (e.g., method shown in FIG. 3) the core and primer fusing agents 14 and 14′ may be used to together to pattern different portions of a single build material layer 12, which will be described further in reference to FIG. 3. Color may also be added by using the coloring agent (not shown), which will also be described further in reference to FIG. 4.

The volume of the fusing agent 14 or 14′ or 14″ that is applied per unit of the build material composition 10 in the patterned portion 16 may be sufficient to absorb and convert enough electromagnetic radiation so that the build material composition 10 in the patterned portion 16 will coalesce/fuse. The volume of the fusing agent 14 or 14′ or 14″ that is applied per unit of the build material composition 10 may depend, at least in part, on the energy absorber used, the energy absorber loading in the fusing agent 14 or 14′ or 14″, and the polyamide particles in the build material composition 10.

The fusing agent 14 or 14′ or 14″ may be dispensed from an applicator 32. The applicator 32 may include a thermal inkjet printhead, a piezoelectric printhead, a continuous inkjet printhead, etc., and the selective application of the fusing agent 14 or 14′ or 14″ may be accomplished by thermal inkjet printing, piezo electric inkjet printing, continuous inkjet printing, etc. The controller may process data, and in response, control the applicator 32 to deposit the fusing agent 14 or 14′ or 14″ onto the predetermined portion(s) 16 of the build material composition 10.

It is to be understood that the selective application of the fusing agent 14 or 14′ or 14″ may be accomplished in a single printing pass or in multiple printing passes. In some examples, the fusing agent 14 or 14′ or 14″ is selectively applied in a single printing pass. In some other examples, the fusing agent 14 or 14′ or 14″ is selectively applied in multiple printing passes. In one of these examples, the number of printing passes ranging from 2 to 4. It may be desirable to apply the fusing agent 14 or 14′ or 14″ in multiple printing passes to increase the amount, e.g., of the energy absorber that is applied to the build material composition 10, to avoid liquid splashing, to avoid displacement of the build material composition 10, etc.

In the example shown in FIG. 1, the detailing agent 34 is also selectively applied to the portion(s) 36 of the layer 12. The portion(s) 36 are not patterned with the fusing agent 14 or 14′ or 14″ and thus are not to become part of the final 3D printed object layer 18. Thermal energy generated during radiation exposure may propagate into the surrounding portion(s) 36 that do not have the fusing agent 14 or 14′ or 14″ applied thereto. The propagation of thermal energy may be inhibited, and thus the coalescence of the non-patterned build material portion(s) 36 may be prevented, when the detailing agent 34 is applied to these portion(s) 36.

The detailing agent 34 may also be dispensed from an applicator 32′. The applicator 32′ may include any of the inkjet printheads set forth herein. It is to be understood that the applicators 32, 32′ may be separate applicators or may be a single applicator with several individual cartridges for dispensing the respective agents 14 or 14′ or 14″ and 34. The detailing agent 34 may also be selectively applied in a single printing pass or in multiple printing passes.

After the agents 14 or 14′ or 14″ and 34 are selectively applied in the specific portion(s) 16 and 36 of the layer 12, the entire layer 12 of the build material composition 10 is exposed to electromagnetic radiation (shown as EMR in FIG. 1).

The electromagnetic radiation is emitted from the radiation source 30. The length of time the electromagnetic radiation is applied for, or energy exposure time, may be dependent, for example, on one or more of: characteristics of the radiation source 30; characteristics of the build material composition 10; and/or characteristics of the fusing agent 14 or 14′ or 14″.

It is to be understood that the electromagnetic radiation exposure may be accomplished in a single radiation event or in multiple radiation events. In an example, the exposing of the build material composition 10 is accomplished in multiple radiation events. In a specific example, the number of radiation events ranges from 3 to 8. In still another specific example, the exposure of the build material composition 10 to electromagnetic radiation may be accomplished in 3 radiation events. It may be desirable to expose the build material composition 10 to electromagnetic radiation in multiple radiation events to counteract a cooling effect that may be brought on by the amount of the agents 14 or 14′ and 34 that is applied to the build material layer 12. Additionally, it may be desirable to expose the build material composition 10 to electromagnetic radiation in multiple radiation events to sufficiently elevate the temperature of the build material composition 10 in the portion(s) 16, 36, without over heating the build material composition 10 in the non-patterned portion(s) 36.

The fusing agent 14 or 14′ or 14″ enhances the absorption of the radiation, converts the absorbed radiation to thermal energy, and promotes the transfer of the thermal heat to the build material composition 10 in contact therewith. In an example, the fusing agent 14 or 14′ or 14″ sufficiently elevates the temperature of the build material composition 10 in the portion 16 to a temperature above the melting point of the polyamide particles, allowing coalescing/fusing (e.g., thermal merging, melting, binding, etc.) of the build material composition 10 to take place. The application of the electromagnetic radiation forms the 3D printed object layer 18.

In some examples, the electromagnetic radiation has a wavelength ranging from 100 nm to 400 nm, from 400 nm to 4000 nm, or from 800 nm to 1400 nm, or from 800 nm to 1200 nm. The radiation used will depend upon the fusing agent 14 or 14′ or 14″ that is used. Radiation having wavelengths within the appropriate ranges may be absorbed by the fusing agent 14 or 14′ or 14″ and may heat the build material composition 10 in contact therewith, and may not be absorbed by the non-patterned build material composition 10 in portion(s) 36.

After the 3D printed object layer 18 is formed, additional layer(s) may be formed thereon to create an example of the 3D printed polyamide object. To form the next layer, additional build material composition 10 may be applied on the layer 18. The fusing agent 14 or 14′ or 14″ is then selectively applied on at least a portion of the additional build material composition 10, according to data derived from the 3D object model. The detailing agent 34 may be applied in any area of the additional build material composition 10 where coalescence is not desirable. After the agent(s) 14 or 14′ or 14″ and 34 is/are applied, the entire layer of the additional build material composition 10 is exposed to electromagnetic radiation in the manner described herein. The application of additional build material composition 10, the selective application of the agent(s) 14 or 14′ or 14″ and 34, and the electromagnetic radiation exposure may be repeated a predetermined number of cycles to form the final 3D printed polyamide object in accordance with the 3D object model.

Printing with the Core and Primer Fusing Agents

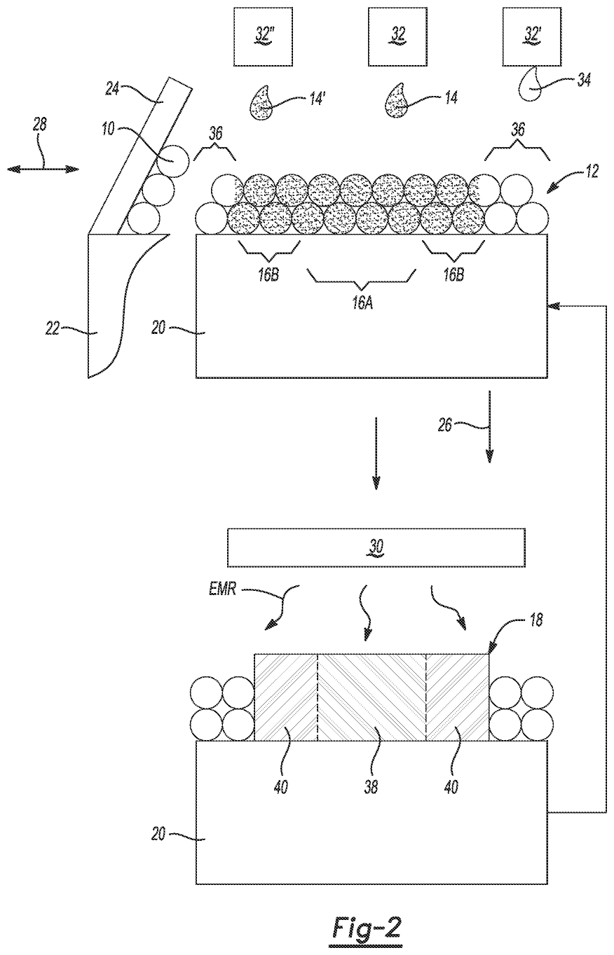

Referring now to FIG. 2, an example of the 3D printing method with both of the fusing agents 14 and 14′ is depicted.

The method shown in FIG. 2 includes applying a build material composition 10 to form a build material layer 12; based on data derived from a digital 3D object model, selectively applying a core fusing agent 14 onto the build material layer 12, thereby forming a first patterned portion 16A; based on the data derived from the 3D object model, selectively applying a primer fusing agent 14′ onto the build material layer 12, thereby forming a second patterned portion 16B adjacent to the first patterned portion 16A; and exposing the build material layer 12 to electromagnetic radiation EMR to selectively coalesce the patterned portions 16A and 16B and form a 3D printed object layer 18′.

In FIG. 2, one layer 12 of the build material composition 10 is applied on the build area platform 20 as described in reference to FIG. 1. After the build material composition 10 has been applied, and prior to further processing, the build material layer 12 may be exposed to pre-heating as described in reference to FIG. 1.

In this example of the 3D printing method, the core fusing agent 14 is selectively applied on at least some of the build material composition 10 in the layer 12 to form a first patterned portion 16A; and the primer fusing agent(s) 14′ is selectively applied on at least some of the build material composition 10 in the layer 12 to form second patterned portion(s) 16B that are adjacent to the first patterned portion(s) 16A. In one example, the first patterned portion 16A (patterned with the core fusing agent 14) may be located at an interior portion of the build material layer 12 to impart mechanical strength, and the second patterned portion 16B (patterned with the primer fusing agent 14′) may be located at an exterior portion of the build material layer 12 to mask the color of the first patterned portion 16A.

The volume of the core fusing agent 14 that is applied per unit of the build material composition 10 in the first patterned portion 16A may be sufficient to absorb and convert enough electromagnetic radiation so that the build material composition 10 in the patterned portion 16A will coalesce/fuse.

The volume of the primer fusing agent 14′ that is applied per unit of the build material composition 10 in the second patterned portion 16B may be sufficient to absorb and convert enough electromagnetic radiation so that the build material composition 10 in the second patterned portion 16B will coalesce/fuse.

In the example shown in FIG. 2, the detailing agent 34 is also selectively applied to the portion(s) 36 of the layer 12. The portion(s) 36 are not patterned with the fusing agent 14 or 14′ and thus are not to become part of the final 3D printed object layer 18′.

After the agents 14, 14′, and 34 are selectively applied in the specific portion(s) 16A, 16B, and 36 of the layer 12, the entire layer 12 of the build material composition 10 is exposed to electromagnetic radiation (shown as EMR in FIG. 2). Radiation exposure may be accomplished as described in reference to FIG. 1.

In this example, the respective fusing agents 14 and 14′ enhance the absorption of the radiation, convert the absorbed radiation to thermal energy, and promote the transfer of the thermal heat to the build material composition 10 in contact therewith. In an example, the fusing agents 14 and 14′ sufficiently elevate the temperature of the build material composition 10 in the respective portions 16A, 16B to a temperature above the melting point of the polyamide12 particles, allowing coalescing/fusing (e.g., thermal merging, melting, binding, etc.) of the build material composition 10 to take place. The application of the electromagnetic radiation forms the 3D printed object layer 18′, which, in this example, includes a core portion 38 and primer portions 40 at opposed ends of the core portion 38.

FIG. 2 illustrates one example of how the core fusing agent 14 and the primer fusing agent 14′ may be used together to pattern a single build material layer 12 and form one layer 18′ of the 3D printed object.

FIG. 3 is a cross-section of a 3D printed object 42 that can be formed with both the core fusing agent 14 and the primer fusing agent 14′. In this example, the 3D printed object 42 includes a predetermined number core portions 38, and a predetermined number of primer portions 40. To form this example of the 3D printed object 42, the core fusing agent 14 would be applied on multiple layers of the build material composition 10 (illustrated by the dashed horizontal lines in FIG. 3) to pattern and ultimately form the inner core portion 38, I of the 3D printed object 42, and the primer fusing agent 14′ would be applied on multiple layers of the build material composition 10 to pattern and ultimately form the outermost primer portions 40, O of the 3D printed polyamide object 42. After each build material layer 12 is patterned with the agent(s) 14, 14′, electromagnetic radiation may be applied to solidify the respective patterned build material layers.

FIG. 4 is a cross-section of another 3D printed object 42′ that can be formed with both the core fusing agent 14 and the primer fusing agent 14′. In this example, the core fusing agent 14 is utilized to form the core (e.g., the center or inner-most portion) of the 3D printed object 42′, and the primer fusing agent 14′ is used to form the outermost layers of the 3D printed object 42′. The core fusing agent 14 can impart strength to the core of the 3D printed polyamide object 42′, while the primer fusing agent 14′ enables white or a color to be exhibited at the exterior of the 3D printed polyamide object 42′.

To form this example of the 3D printed object 42′, the outermost build material layer(s) and the outermost edges of the middle build material layers would be patterned with the primer fusing agent 14′ to form primer portions 40 of the 3D printed object 42′. The innermost portions of the middle build material layers would be patterned with the core fusing agent 14 to form the core portions 38 of the 3D printed object 42′. In this example, any number of core portions 38 may be formed, and any number of primer portions 40 may be formed.

While several variations of the 3D printed objects 42, 42′ and the combination of the cores and primer fusing agents 14, 14′ have been described, it is to be understood that any of the fusing agents 14, 14′, 14″ may be used to form any desirable 3D printed object.

In any of the example 3D printing methods that utilize the fusing agent(s) 14, 14′, 14″, the coloring agent (not shown) may also be applied with the primer fusing agent 14′ or the UV light fusing agent 14″ to generate color at the exterior surfaces of the 3D printed object, such as object 42 or object 42′. In these examples, the colorant of the coloring agent becomes embedded throughout the coalesced/fused build material composition wherever it is applied. In an example, the coloring agent may be applied with the primer fusing agent 14′ on the portions of the build material layers that form the primer portions 40 in FIG. 4. Since the primer fusing agent 14′ is clear or slightly tinted and the build material composition 12 is white or off-white, the color of the coloring agent will be the color of the resulting primer portions 40. Similarly, since the UV light fusing agent 14″ is clear or slightly tinted and the build material composition 12 is white or off-white, the coloring agent may be used with this fusing agent 14″ to impart color at desirable portions of the resulting 3D printed object.

When core and primer portions 38, 40 are formed (FIG. 3 and FIG. 4) and the coloring agent is used, it is to be understood that some of the primer portions 40 directly adjacent to the core portions 40 may be left uncolored. In this example, the uncolored primer portions 40 are white or slightly tinted, and may function as intermediate layers that help to form a mask over the black (or dark colored) core layers 38. The presence of uncolored primer portions 40 between core portions 38 and primer portions 40 that are colored with the coloring agent may help to optically isolate the core layers 38.

Additionally, in the examples disclosed herein that utilize a fusing agent, the 3D printed object 42, 42′ may be printed in any orientation with respect to the X-Y plane of the build area platform 20, and thus with respect to the layers 12 of the build material composition 10. For example, the 3D printed object 42, 42′ can be printed from bottom to top in the Z-direction, or at an inverted orientation (e.g., from top to bottom) in the Z-direction. For another example, the 3D printed object 42, 42′ can be printed at an angle or on its side. The orientation of the build within the build material composition 10 can be selected in advance or even by the user at the time of printing, for example.

Because the aramid fibers disclosed herein orient themselves in the spreading direction, it may be desirable to print the 3D object in the spreading direction. When an object is printed in a particular direction (e.g., X-, Y-, or Z-direction), it is meant that a load-bearing direction a 3D object being printed extends along the spreading direction. As such, when the build material composition 10 is spread in the Y-direction, it is also desirable that the length of the 3D object being printed also extend along the Y-direction. In this particular example, the 3D object may be printed from bottom to top in the Z-direction, but the load-bearing direction of the 3D object extends in the Y-direction (or the X-direction if that corresponds to the spreading direction).

Printinq with Selective Laser Sinterinq

In other examples, the 3D printing process may involve Selective Laser Sintering (SLS). In these examples, the build material composition 10 may be spread across the surface 21 of the build area platform 20 as described herein in reference to FIG. 1.

Portion(s) of the uniformly spread layer 12 of the build material composition 10 is/are then exposed to a laser beam of high energy density. The laser spot scans the surface of the layer 12 of the spread build material composition 10, and emits a narrow energy beam in portion(s) that are to become part of the 3D printed object. The narrow beam heats the exposed polyamide particles in the build material composition 10 such that they coalesce. The laser is moved in the X- and/or Y-direction to heat and coalesce the portion(s) of the build material composition 10 in a given layer 12. After one layer 12 is printed, an additional layer of the build material composition 10 is applied and the laser exposure is repeated in a desired pattern.

The stacked coalesced layers produce the final 3D printed object (i.e., each subsequent laser-patterned layer is formed on top of the previous one).

To further illustrate the present disclosure, examples are given herein. It is to be understood that these examples are provided for illustrative purposes and are not to be construed as limiting the scope of the present disclosure.

### EXAMPLES

### Example 1

### Aramid Fiber Comparison

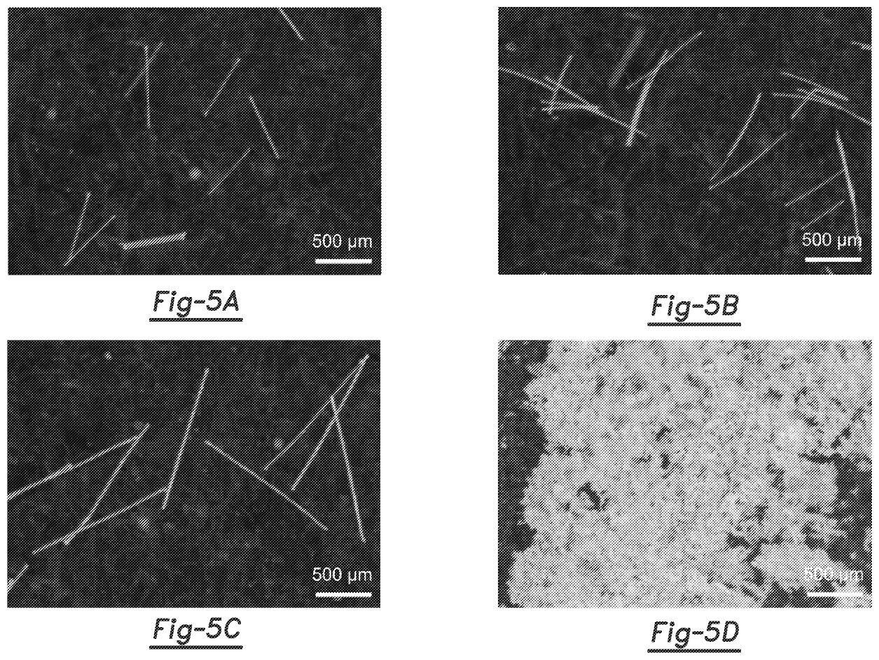

Aramid fibers (KF 100-01 from Tech-in Material Co. Ltd.) with three different average aspect ratios were used in example build material compositions. The average diameters of the aramid fibers were the same (16 μm), and the average lengths varied as follows: Example 1 fibers=0.5 mm; Example 2 fibers=0.7 mm, and Example 3 fibers=1.2 mm. Microscope images of the Example 1, 2, and 3 fibers are shown in FIG. 5A through FIG. 5C, respectively.

Comparative aramid fibers were also used to generate one comparative example build material formulation. These fibers are referred to as Comparative Example 4 fibers. The Comparative Example 4 fibers were of random form, and thus had no defined aspect ratio. A microscope image of the Comparative Example 4 fibers is shown in FIG. 5D.

FIG. 5A through FIG. 5D clearly illustrate the physical differences between the aramid fibers with the defined average aspect ratio versus the random form aramid fibers.

### Build Material Compositions

Several different build material compositions were prepared. Each of the build material compositions included polyamide particles (High Reusability PA 12 powder from HP Inc.).

The example build material compositions included different weight percentages of the Example 1 fibers (average aspect ratio: 0.5 mm/16 μm), the Example 2 fibers (average aspect ratio: 0.7 mm/16 μm), or the Example 3 fibers (average aspect ratio: 1.2 mm/16 μm). Some of the comparative build material compositions included different weight percentages of the Comparative Example 4 fibers (random form (RF)). Another of the comparative build material compositions included the polyamide particles without any added filler.

The build material compositions that included aramid fibers (example or comparative) were prepared by mixing the polyamide particles and the respective aramid fibers in a mechanical mixer (Inversina 2L, Bioengineering AG, Switzerland) at a rotation speed of 60 rpm for about 4 hours. Prior to mixing, the aramid fibers were sieved through a 1 mm mesh.

The color of each composition was observed visually. The white, off-white, and pale yellow colors are suitable for the 3D printing techniques disclosed herein.

The build material compositions and their respective colors are shown in Table 1.

TABLE 1
Build material Compositions and Color

| | Aramid Fibers | | | | | |
|---|---|---|---|---|---|---|
| | Ex. 1 | Ex. 2 | Ex. 3 | Comp. Ex. | | |
| Build | fibers | fibers | fibers | 4 fibers | PA-12 | |
| Material | (0.5 mm) | (0.7 mm) | (1.2 mm) | (RF) | Particles | |
| Comp. ID | (wt %) | (wt %) | (wt %) | (wt %) | (wt %) | Color |
| Ex. 1A | 2 | — | — | — | 98 | White |
| Ex. 1B | 4 | — | — | — | 96 | Off-white |
| Ex. 1C | 6 | — | — | — | 94 | Off-white |
| Ex. 1D | 8 | — | — | — | 92 | Pale Yellow |
| Ex. 1E | 10 | — | — | — | 90 | Pale Yellow |
| Ex. 1F | 12 | — | — | — | 88 | Pale Yellow |
| Ex. 1G | 14 | — | — | — | 86 | Pale Yellow |
| Ex. 2A | — | 2 | — | — | 98 | White |
| Ex. 2B | — | 4 | — | — | 96 | Off-white |
| Ex. 2C | — | 6 | — | — | 94 | Off-white |
| Ex. 2D | — | 8 | — | — | 92 | Pale Yellow |
| Ex. 2E | — | 10 | — | — | 90 | Pale Yellow |
| Ex. 3A | — | — | 2 | — | 98 | White |
| Ex. 3B | — | — | 4 | — | 96 | Off-white |
| Comp. | — | — | — | 4 | 96 | Off-white |
| Ex. 4A | | | | | | |
| Comp. | — | — | — | 8 | 92 | Pale Yellow |
| Ex. 4B | | | | | | |
| Comp. | — | — | — | 12 | 88 | Pale Yellow |
| Ex. 4C | | | | | | |
| Comp. | — | — | — | — | 100 | White |
| Ex. 5 | | | | | | |

### 3D Printed Objects

All of the build material compositions were used to print dog bone shaped 3D objects. Four (4) dog bone shaped 3D objects were generated for each of the build material compositions, and the test results set forth herein depict the average for the 4 dog bone shaped 3D objects. The objects are identified by the build material composition used to form the object as shown in Table 2.

TABLE 2
3D Printed Objects

| | Build Material Comp. ID |
|---|---|
| 3D Object ID | (Fiber Length or Type/Wt %) |
| Ex. Object 1A | Ex. 1A |
| | (0.5 mm/2 wt %) |
| Ex. Object 1B | Ex. 1B |
| | (0.5 mm/4 wt %) |
| Ex. Object 1C | Ex. 1C |
| | (0.5 mm/6 wt %) |
| Ex. Object 1D | Ex. 1D |
| | (0.5 mm/8 wt %) |
| Ex. Object 1E | Ex. 1E |
| | (0.5 mm/10 wt %) |
| Ex. Object 1F | Ex. 1F |
| | (0.5 mm/12 wt %) |
| Ex. Object 1G | Ex. 1G |
| | (0.5 mm/14 wt %) |
| Ex. Object 2A | Ex. 2A |
| | (0.7 mm/2 wt %) |
| Ex. Object 2B | Ex. 2B |
| | (0.7 mm/4 wt %) |
| Ex. Object 2C | Ex. 2C |
| | (0.7 mm/6 wt %) |
| Ex. Object 2D | Ex. 2D |
| | (0.7 mm/8 wt %) |
| Ex. Object 2E | Ex. 2E |
| | (0.7 mm/10 wt %) |
| Ex. Object 3A | Ex. 3A |
| | (1.2 mm/2 wt %) |
| Ex. Object 3B | Ex. 3B |
| | (1.2 mm/4 wt %) |
| Comp. Ex. Object 4A | Comp. Ex. 4A |
| | (RF/4 wt %) |
| Comp. Ex. Object 4B | Comp. Ex. 4B |
| | (RF/8 wt %) |
| Comp. Ex. Object 4C | Comp. Ex. 4C |
| | (RF/12 wt %) |
| Comp. Ex. Object 5 | Comp. Ex. 5 |
| | (n/a) |

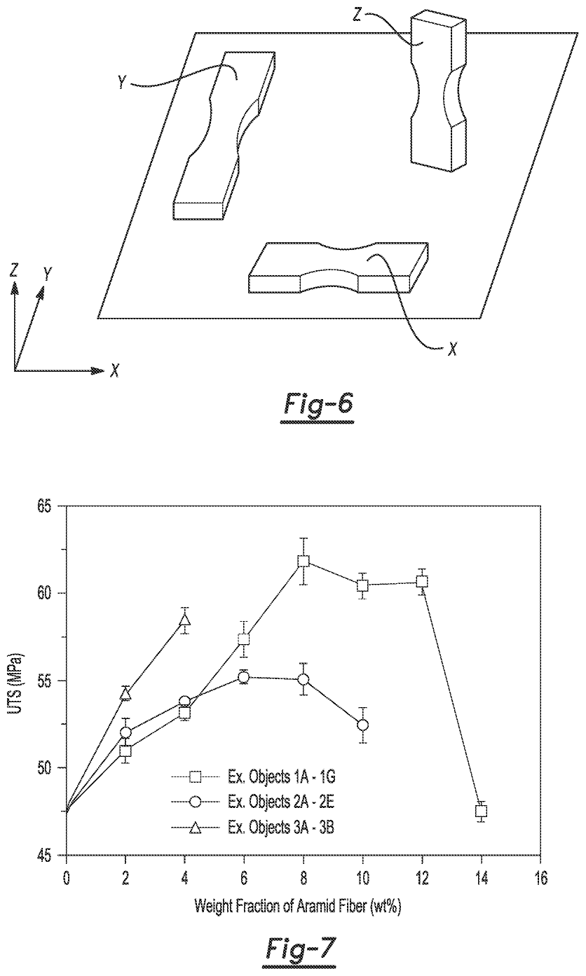

All of the dog bone shaped 3D object were printed on a small testbed 3D printer with the build material composition being spread in the Y-direction to layer thicknesses of 80 μm. A fusing agent (that included carbon black as the energy absorber) was printed over 2 passes in the X-direction. After the fusing agent was dispensed, the entire build area platform was exposed to near-infrared energy. The process was repeated until the entire object was formed. Each the example and comparative example build materials were printed in the X-direction and the Y-direction. FIG. 6 schematically illustrates dog bone shaped 3D objects, X, printed in the X-direction, dog bone shaped 3D objects, Y, printed in the Y-direction, and dog bone shaped 3D objects, Z, printed in the Z-direction. All of the dog bone shaped 3D objects were allowed to cool to room temperature, and then were cleaned using bead blasting.

The mechanical properties of the dog bone shaped 3D objects printed in the X- and Y-directions were measured by tensile tests in accordance with the American Society for Testing and Materials (ASTM) D638 Type V standard and 3-point bending tests. The results are shown in Table 3.

TABLE 3
Mechanical Properties - X- and Y-directions

| | Ultimate Tensile | | Young's Modulus | | Elongation | |
|---|---|---|---|---|---|---|
| | Strength (MPa) | | (GPa) | | (%) | |
| 3D Object | X- | Y- | X- | Y- | X- | Y- |
| ID | direction | direction | direction | direction | direction | direction |
| Ex. Object | 47.54 ± 0.37 | 50.94 ± 0.70 | 1.96 ± 0.09 | 2.07 ± 0.01 | 41.80 ± 5.50 | 64.24 ± 7.12 |
| 1A | | | | | | |
| Ex. Object | 46.23 ± 0.76 | 53.11 ± 0.44 | 1.96 ± 0.16 | 2.68 ± 0.13 | 25.35 ± 5.68 | 23.59 ± 1.62 |
| 1B | | | | | | |
| Ex. Object | 44.88 ± 0.31 | 57.32 ± 1.08 | 2.15 ± 0.12 | 2.91 ± 0.07 | 16.02 ± 3.53 | 13.48 ± 1.91 |
| 1C | | | | | | |
| Ex. Object | 43.12 ± 1.24 | 61.79 ± 1.33 | 2.15 ± 0.04 | 3.66 ± 0.34 | 10.68 ± 0.92 | 7.59 ± 0.56 |
| 1D | | | | | | |
| Ex. Object | 35.93 ± 3.03 | 60.41 ± 0.70 | 1.93 ± 0.18 | 4.14 ± 0.44 | 6.57 ± 2.83 | 5.90 ± 0.93 |
| 1E | | | | | | |
| Ex. Object | 29.70 ± 4.09 | 60.61 ± 0.73 | 1.49 ± 0.07 | 4.71 ± 0.31 | 2.78 ± 0.04 | 4.84 ± 0.59 |
| 1F | | | | | | |
| Ex. Object | 22.95 ± 0.49 | 47.46 ± 0.57 | 1.28 ± 0.07 | 4.11 ± 0.28 | 2.34 ± 0.11 | 4.45 ± 0.49 |
| 1G | | | | | | |
| Ex. Object | 51.17 ± 0.52 | 51.97 ± 0.74 | 2.04 ± 0.05 | 2.25 ± 0.14 | 31.35 ± 3.03 | 36.87 ± 2.55 |
| 2A | | | | | | |
| Ex. Object | 46.56 ± 1.63 | 53.78 ± 0.11 | 1.87 ± 0.01 | 2.18 ± 0.10 | 20.44 ± 3.62 | 22.74 ± 2.67 |
| 2B | | | | | | |
| Ex. Object | 45.58 ± 1.19 | 55.18 ± 0.36 | 1.74 ± 0.05 | 2.34 ± 0.05 | 20.24 ± 5.34 | 17.84 ± 1.11 |
| 2C | | | | | | |
| Ex. Object | 42.40 ± 0.14 | 55.02 ± 0.89 | 1.65 ± 0.09 | 2.37 ± 0.07 | 12.40 ± 1.62 | 15.25 ± 1.19 |
| 2D | | | | | | |
| Ex. Object | 33.53 ± 0.10 | 52.41 ± 1.00 | 1.18 ± 0.05 | 2.18 ± 0.20 | 8.64 ± 0.16 | 11.04 ± 1.10 |
| 2E | | | | | | |
| Ex. Object | 47.71 ± 0.22 | 54.16 ± 0.34 | 1.82 ± 0.16 | 2.13 ± 0.07 | 38.50 ± 4.01 | 54.01 ± 5.18 |
| 3A | | | | | | |
| Ex. Object | 40.5 6 ± 1.27 | 58.40 ± 0.74 | 1.50 ± 0.04 | 2.79 ± 0.18 | 12.99 ± 2.89 | 11.47 ± 1.63 |
| 3B | | | | | | |
| Comp. Ex. | 47.77 ± 0.84 | 45.58 ± 0.80 | 1.69 ± 0.01 | 1.70 ± 0.04 | 51.94 ± 3.08 | 54.70 ± 10.73 |
| Object 4A | | | | | | |
| Comp. Ex. | 46.68 ± 0.37 | 45.21 ± 1.39 | 1.79 ± 0.06 | 1.81 ± 0.06 | 28.41 ± 1.18 | 16.81 ± 3.96 |
| Object 4B | | | | | | |
| Comp. Ex. | 46.61 ± 0.86 | 46.86 ± 1.35 | 1.89 ± 0.07 | 2.09 ± 0.12 | 25.60 ± 5.04 | 14.99 ± 1.09 |
| Object 4C | | | | | | |
| Comp. Ex. | 46.15 ± 0.46 | 47.56 ± 0.02 | 1.55 ± 0.10 | 1.69 ± 0.05 | 204.53 ± 26.48 | 92.30 ± 18.45 |
| Object 5 | | | | | | |

The ultimate tensile strength (UTS) results for the comparative example objects 4A, 4B, 4C formed with the random form aramid fibers were similar to those for the comparative example object 5 formed with neat PA-12 particles. All of the comparative example objects exhibited mechanical isotropy, as there was no significant difference in the UTS between the objects printed in the X- and Y-directions.

In contrast, the example objects (1A-1G, 2A-2E, 3A and 3B) exhibited mechanical anisotropy, as there was a significant difference in the UTS between the objects printed in the X- and Y-directions. In particular, each of the example objects (1A-1 G, 2A-2E, 3A and 3B) had improved UTS when printed in the Y-direction.

The UTS results for the example objects printed in the Y-direction are plotted in FIG. 7. As illustrated, the UTS in the Y-direction initially increased with an increase in the fiber fraction, and then decreased with an increase in the fiber fraction. These results revealed that a particularly desirable fiber fraction for the fiber lengths of 0.5 mm, 0.7 mm, and 1.2 mm were 8 wt %, 6 wt %, and 4 wt %, respectively. The UTS results also illustrate that the example 3D objects with longer fibers exhibited better strength than the example 3D objects with the same fiber fraction (e.g., compare Ex. Object 3B with Ex. Objects 1B and 2B). However, the shorter aramid fibers enable the possibility for loading more fibers to achieve better mechanical performance.

Higher fiber fraction and longer fibers may lead to decreased powder flowability and increased porosity in the 3D objects.

The effect of build orientation was further investigated with Ex. Object 1B (4 wt %, 0.5 mm aramid fibers), Ex. Object 1 D (8 wt %, 0.5 mm aramid fibers), Ex. Object 1F (12 wt %, 0.5 mm aramid fibers), and Comp. Ex. 5 printed in the X-direction and printed the Y-direction. For this investigation, additional 3D objects were printed in the Z-direction using build material compositions Ex. 1B (4 wt % of the 5 mm length aramid fibers), Ex. 1 D (8 wt % of the 5 mm length aramid fibers), and Ex. 1F (12 wt % of the 5 mm length aramid fibers), and build material composition Comp. Ex. 5 (100 wt % PA-12 particles). The additional dog bone shaped 3D objects were printed on the small testbed 3D printer with the build material composition being spread in the Y-direction to form layer thicknesses of 80 μm. The fusing agent (that included carbon black as the energy absorber) was applied over 2 passes in the X-direction. After the fusing agent was dispensed, the entire build area platform was exposed to near-infrared energy. The process was repeated until the entire object was formed. The additional dog bone shaped 3D objects were printed in the Z-direction. All of the additional dog bone shaped 3D objects were allowed to cool to room temperature, and then were cleaned using bead blasting.

The mechanical properties of the additional dog bone shaped 3D objects printed in the Z-direction were measured by tensile tests in accordance with the American Society for Testing and Materials (ASTM) D638 Type V standard and 3-point bending tests. The results are shown Table 4.

TABLE 4
Mechanical Properties - Z-direction

| | Ultimate | | |
|---|---|---|---|
| | Tensile | Young's | |
| | Strength | Modulus | Elongation |
| Additional 3D | (MPa) | (GPa) | (%) |
| Object ID | Z-direction | Z-direction | Z-direction |
| Additional Ex. | 50.50 ± 0.34 | 1.93 ± 0.15 | 11.89 ± 4.77 |
| Object 1B | | | |
| Additional Ex. | 36.33 ± 1.15 | 2.02 ± 0.34 | 9.09 ± 2.82 |
| Object 1D | | | |
| Additional Ex. | 13.07 ± 0.76 | 0.95 ± 0.08 | 3.22 ± 0.32 |
| Object 1F | | | |
| Additional | 51.10 ± 2.23 | 1.62 ± 0.07 | 33.18 ± 16.5 |
| Comp. Ex. | | | |
| Object 5 | | | |

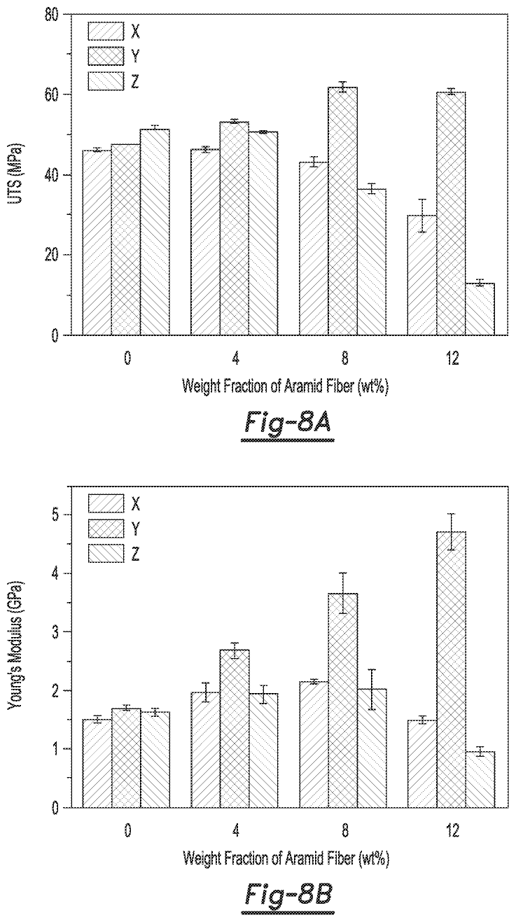

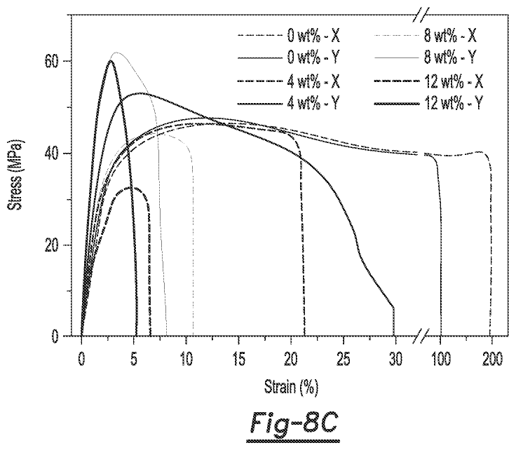

The UTS results for Ex. Objects 1B, 1D, 1F, and Comp. Ex. Object 5 printed in the X-, Y-, and Z-directions are shown in FIG. 8A and the Young's modulus results for Ex. Objects 1B, 1D, 1F, and Comp. Ex. Object 5 printed in the X-, Y-, and Z-directions are shown in FIG. 8B. Ex. Object 1B (4 wt % of the 0.5 mm aramid fibers), Ex. Object 1 D (8 wt % of the 0.5 mm aramid fibers), and Ex. Object 1F (12 wt % of the 0.5 mm aramid fibers) printed in each direction, and especially in the Y-direction, exhibited the best performance for both UTS and Young's modulus. Ex. Object D printed in the Y-direction exhibited the highest UTS (61.79 MPa), which was a 27% increase over Comp. Ex. Object 5 printed in the Y direction. Ex. Object 1F (12 wt % of the 0.5 mm aramid fibers) printed in the Y-direction also exhibited the best Young's modulus (4.71 GPa), which was a 179% increase over Comp. Ex. Object 5 printed in the Y-direction. In comparison, the example objects printed in the X-direction or the Z-direction exhibited lower performance than the same example objects printed in the Y-direction.

FIG. 8C is a graph of the stress-strain curves of Ex. Objects 1B, 1D, 1F, and Comp. Ex. Object 5 printed in the X-direction and the Y-direction. The elongation at break decreased with the fiber fraction.

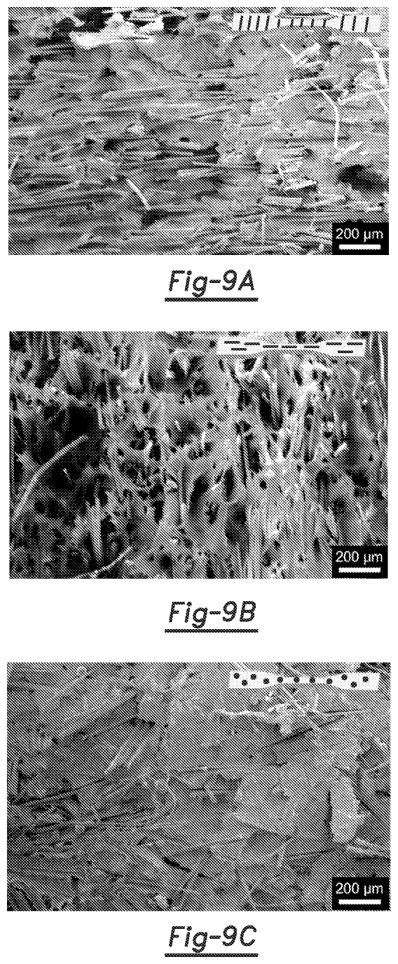

Ex. Objects 1D (8 wt %) printed in each of the X-, Y-, and Z directions were fractured in the gauge section (the skinny portion of the dog bone where deformation and failure can occur more easily), and a scanning electron micrograph (SEM) image of the cross-section of the break was taken. The SEM images illustrating the fracture morphologies are shown in FIG. 9A (Ex. Object 1 D printed in the X-direction), FIG. 9B (Ex. Object 1 D printed in the Y-direction), and FIG. 9C (Ex. Object 1 D printed in the Z-direction). The inset in each of these figures schematically illustrates the alignment of the fibers within the 3D printed objected. These SEM images clearly illustrate the fiber alignment in the spreading direction (Y-direction). In the X- and Z-directions (FIG. 9A and FIG. 9C, respectively), the fibers were predominately oriented in the X-Y plane and thus contributed no strength in between printed layers. The smooth fracture surfaces of the examples objects 1 D printed in the X-direction and 1D printed in the Z-direction demonstrated that the failure mode was primarily brittle. In contrast, the fracture surface of Ex. Object 1 D printed in the Y-direction had its fibers oriented perpendicular to the build area platform, and some holes were created in the matrix as the fibers were dislodged form the coalesced PA-12 matrix. The aligned fibers enable performance enhancement by preventing the crack propagation through energy absorbing processes including fiber fracture, debonding, and pull-out in the PA12 matrix.

The flexural properties (strength and modulus) of Ex. Objects 1B, 1D, 1F, and Comp. Ex. Object 5 printed in the X-, and Y-directions were also investigated. These results are shown in Table 5.

TABLE 5
Flexural Properties

| 3D Object | Flexural Strength (MPa) | | Flexural Modulus (GPa) | |
|---|---|---|---|---|
| ID | X-direction | Y-direction | X-direction | Y-direction |
| Ex. Object | 64.75 ± 1.63 | 79.94 ± 1.57 | 1.43 ± 0.06 | 1.91 ± 0.11 |
| 1B | | | | |
| Ex. Object | 64.19 ± 2.73 | 77.77 ± 0.31 | 1.46 ± 0.08 | 1.85 ± 0.06 |
| 1D | | | | |
| Ex. Object | 60.07 ± 2.41 | 88.45 ± 1.84 | 1.47 ± 0.09 | 2.34 ± 0.08 |
| 1F | | | | |
| Comp. Ex. | 62.85 ± 0.32 | 64.72 ± 0.55 | 1.38 ± 0.05 | 1.28 ± 0.01 |
| Object 5 | | | | |

None of these example or comparative example objects ruptured at maximum deflection. The flexural strength and modulus of Ex. Object F (12%) printed along the spreading (Y-) direction were 88.45 MPa and 2.34 GPa, respectively, which were increased by 37% and 83%, respectively, when compared with the flexural strength and modulus of Comp. Ex. Object 5 printed in the Y-direction. The degree of anisotropy of flexural performance between the X- and Y-directions was lower than that of the UTS.

### Example 2

Powder flowability is a property of the build material compostion that contributes to its recoatability (e.g., non-patterned build material that is collected, mixed with fresh build material composition, and is used again in a 3D printing process), as well as to printed object quality.

The dynamic avalanche angle indicates particle cohesiveness during flow, and a high avalanche angle may lead to undesirable cohesion, resulting in high void fraction of the product.

The dynamic dynamic avalanche angle was tested for build material compositions Ex. 1B, Ex. 1 D, and Ex. 1F and Comp. Ex. 5 of Example 1. The results are shown in Table 6.

TABLE 6
Avalanche Angle

| | | Avalanche |
|---|---|---|
| Build | Median | Angle |
| Material | Avalanche | Distribution |
| Comp. ID | Angle | Range |
| Ex. 1B | 52.7° | 35°-65° |
| Ex. 1D | 54.8° | 35°-65° |
| Ex. 1F | 58.4° | 35°-75° |
| Comp. Ex. 5 | 48.4° | 40°-55° |

With the increment of fiber fraction, the median avalanche angle increased from 48.4° (Comp. Ex. 5, 0 wt % 0.5 mm aramid fibers) to 58.4° (Ex. 1F, 12 wt % 0.5 mm aramid fibers). This may have been due to the mismatch of shape and size between the PA-12 particles and the aramid fibers. Despite the increase in the avalanche angle and its distribution range, the example build material compositions are comparable to some reported powder bed fusion (PBF_grade polymer powders (PA-12 and thermoplastic urethane) which have avalanche angles in the range of 40° to 60°.

A flowability agent was added to build material composition Ex. 1D (8 wt % 0.5 mm aramid fibers) to determine the effect, in any, on the flowability. This example build material is referred to as Ex. 1 D-FA. To generate Ex. 1 D-FA, 0.2 wt % silica (hydrophobic fumed silica, R504, from AEROSIL) was added into build material composition Ex. 1 D.

The avalanche angle of Ex. 1 D-FA was tested. The addition of silica caused the avalanche angle to decrease from 54.8° (Ex. 1 D) to 45.6° (Ex. 1 D-FA).

Additional 3D objects were printed with Ex. 1 D-FA in the Y-direction in the same manner described in Example 1 to compare the effect of the silica on the tensile properties. The results are shown in Table 7, where the results for Ex. Object 1 D are reproduced from Table 3. These results illustrate that the silica had an insignificant effect on the tensile properties of the printed parts.

TABLE 7
Mechanical Properties

| | | Ultimate | | |
|---|---|---|---|---|
| | | Tensile | Young's | |
| | Silica | Strength | Modulus | Elongation |
| 3D Object | Flow | (MPa) | (GPa) | (%) |
| ID | Aid | Y-direction | Y-direction | Y-direction |
| Ex. Object | none | 61.79 ± 1.33 | 3.66 ± 0.34 | 7.59 ± 0.56 |
| 1D | | | | |
| Ex. Object | 0.2 | 60.04 ± 1.78 | 3.74 ± 0.53 | 9.93 ± 0.37 |
| 1D-FA | wt % | | | |

It is to be understood that the ranges provided herein include the stated range and any value or sub-range within the stated range, as if the value(s) or sub-range(s) within the stated range were explicitly recited. For example, a range from about 2 wt % to about 18 wt %, should be interpreted to include not only the explicitly recited limits of from about 2 wt % to about 18 wt %, but also to include individual values, such as about 2.75 wt %, 8 wt %, 14 wt %, 15.5 wt %, etc., and sub-ranges, such as from about 5 wt % active to about 15 wt % active, from about 3 wt % active to about 17 wt % active, from about 2 wt % active to about 14 wt % active, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A three-dimensional (3D) printing build material composition, comprising:
polyamide particles present in an amount of at least 82 wt % based on a total weight of the build material composition; and
a filler material consisting of aramid fibers having an average aspect ratio ranging from about 0.1 mm/20 μm to about 1.2 mm/16 μm, the aramid fibers present in an amount ranging from about 2 wt % to about 18 wt % based on the total weight of the build material composition.

2. The 3D printing build material composition as defined in claim 1, further comprising a flow aid present in an amount up to 0.2 wt % based on the total weight of the build material composition.

3. The 3D printing build material composition as defined in claim 1, wherein the average aspect ratio of the aramid fibers ranges from about 0.5 mm/20 μm to about 0.55 mm/16 μm, and the aramid fibers are present in an amount ranging from about 2 wt % to about 14 wt % based on the total weight of the build material composition.

4. The 3D printing build material composition as defined in claim 1, wherein the average aspect ratio of the aramid fibers ranges from about 0.7 mm/20 μm to about 0.85 mm/16 μm, and the aramid fibers are present in an amount ranging from about 2 wt % to about 10 wt % based on the total weight of the build material composition.

5. The 3D printing build material composition as defined in claim 1, wherein the average aspect ratio of the aramid fibers ranges from about 1.1 mm/20 μm to about 1.2 mm/16 μm, and the aramid fibers are present in an amount ranging from about 2 wt % to about 4 wt % based on the total weight of the build material composition.

6. The 3D printing build material composition as defined in claim 1, wherein the polyamide particles are present in an amount up to about 98 wt % based on the total weight of the build material composition.

7. A three-dimensional (3D) printed article, comprising:
coalesced build material, including:
polyamide particles present in an amount of at least 80 wt % based on a total weight of the 3D printed article; and
a filler material consisting of aramid fibers having an average aspect ratio ranging from about 0.1 mm/20 μm to about 1.2 mm/16 μm, the aramid fibers present in an amount ranging from about 1 wt % to about 18 wt % based on the total weight of the 3D printed article.

8. The 3D printed article as defined in claim 7, wherein the coalesced build material further includes a flow aid present in an amount up to 0.2 wt % based on the total weight of the 3D printed article.

9. The 3D printed article as defined in claim 7, further comprising a coloring agent applied on an exterior of the 3D printed article or incorporated into at least a portion of the coalesced build material, the coloring agent being selected from the group consisting of a black agent, a cyan agent, a magenta agent, and a yellow agent.

10. The 3D printed article as defined in claim 7, further comprising an energy absorber intermingled with the coalesced build material, wherein the energy absorber:
exhibits absorption at least at some wavelengths within a range of from 100 nm to 4000 nm; or
exhibits absorption at wavelengths ranging from 100 nm to 400 nm or 800 nm to 4000 nm and has transparency at wavelengths ranging from 400 nm to 780 nm.

11. A three-dimensional (3D) printing method, comprising:
spreading a build material composition to form a build material layer, the build material composition including:
polyamide particles present in an amount of at least 82 wt % based on a total weight of the build material composition; and
a filler material consisting of aramid fibers having an average aspect ratio ranging from about 0.1 mm/20 μm to about 1.2 mm/16 μm, the aramid fibers present in an amount ranging from about 2 wt % to about 18 wt % based on the total weight of the build material composition; and
coalescing at least some of the build material composition in the build material layer by:
i) based on data derived from a digital 3D object model, selectively applying a fusing agent on at least a portion of the build material layer; and
exposing the build material layer to electromagnetic radiation to coalesce the build material composition in the at least the portion, thereby forming a layer of a 3D object; or
ii) based on data derived from a digital 3D object model, selectively exposing the at least some of the build material composition in the build material layer to a laser beam.

12. The method as defined in claim 11, wherein prior to spreading, the method further comprises applying the build material composition to a build area platform having an X-Y plane.

13. The method as defined in claim 12, wherein the spreading is performed in a Y-direction of the X-Y plane.

14. The method as defined in claim 13, wherein a load-bearing direction of a 3D object being printed extends along the Y-direction.

15. The method as defined in claim 11, further comprising:
iteratively applying individual build material layers of the build material composition; and
iteratively coalescing at least some of the build material composition in each of the build material layers.
